(19) United States
(12) Patent Application Publication
(10) Pub. No.: US 2015/0161557 A1
(43) Pub. Date: Jun. 11, 2015

(54) INVENTORY RECONCILIATION DEVICE

(71) Applicant: Verizon Patent and Licensing Inc., Basking Ridge, NJ (US)

(72) Inventors: Joseph HUNTLEY, Fort Lee, NJ (US); Brian T. Wade, Pawcatuck, CT (US)

(73) Assignee: Verizon Patent and Licensing Inc., Basking Ridge, NJ (US)

(21) Appl. No.: 14/100,490

(22) Filed: Dec. 9, 2013

(51) Int. Cl. G06Q 10/08

(52) U.S. Cl. CPC G06Q 10/087

(57) ABSTRACT

A device is configured to receive inventory records and field records. The inventory records may include information that identifies how a network is supposedly configured to provide a service to customers. The field record may include information that identifies how the network is actually configured to provide the service to customers. The device is configured to determine matching constraints and compare the inventory records to the field records to determine matching metrics. The device is configured to evaluate the matching constraints based on the matching metrics, and to determine reconciled records based on evaluating the matching metrics. A reconciled record may include a particular inventory record and a particular field record that matches the particular inventory record. The device is configured to update the inventory records based on the reconciled records.

### BACKGROUND

A service provider (e.g., a telecommunications provider) may provide a service (e.g., internet service, telephone service, etc.) to a customer via a point-to-multipoint network. The point-to-multipoint network may include a variety of network devices configured in a variety of ways to provide the service to the customer.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIGS. 4A-4B are flow charts of an example process for reconciling a set of inventory records with a set of field records associated with a point-to-multipoint network;

FIG. 5 is a flow chart of an example process relating to process 400;

FIG. 6 is a flow chart of another example process relating to process 400; and

FIGS. 7A-7E are diagrams of an example implementation relating to the example process shown in FIG. 4.

### DETAILED DESCRIPTION OF PREFERRED EMBODIMENTS

The following detailed description of example implementations refers to the accompanying drawings. The same reference numbers in different drawings may identify the same or similar elements.

A service provider (e.g., an internet service provider, a telephone service provider, etc.) may provide a service (e.g., internet service, telephone service, etc.) to a customer via a point-to-multipoint network. The point-to-multipoint network may permit the customer to receive the service via one or more network devices configured in a variety of ways. For example, the network may include a passive optical network, and the customer may receive the service by use of one or more fiber distribution hubs and/or fiber distribution terminals. The service provider may generate an inventory record, associated with the customer, which identifies how the one or more network devices are configured to provide service to the customer (e.g., that identifies a particular path through the network from the service provider to the customer).

However, the inventory record may not actually reflect how the one or more network devices are actually configured in the network. For example, a technician associated with the service provider may deviate from the inventory record when connecting, disconnecting, and/or servicing a customer (e.g., by connecting the customer to a different fiber distribution terminal, by using a different optical splitter port and/or distribution panel port associated with the fiber distribution hub, etc.). Over time, the actual conditions in the network may differ significantly from a set of inventory records.

To reconcile the set of inventory records associated with a portion of the network, a technician may need to manually inspect a quantity of fiber distribution hubs and/or fiber distribution terminals to determine how conditions in the field deviate from the set of inventory records. This process of manual reconciliation may be time consuming as it requires the technician to physically visit the fiber distribution hubs and/or fiber distribution terminals associated with the inventory records to be reconciled. Additionally, the fiber distribution hubs and/or fiber distribution terminals may be in locations that are difficult to reach (e.g., on the premises of a customer, on a side of a building, on a telephone pole, etc.). Further, manual reconciliation may require the technician to disconnect portions of the network (e.g., cross connectors associated with the fiber distribution hub) to determine the conditions in the field, which may cause customers to lose service for a period of time.

Implementations described herein may allow a reconciliation device to automatically reconcile a set of inventory records with a set of field records, may minimize the quantity of network devices a technician may need to manually inspect, may minimize service disruptions to customers, and may permit a service provider to recover unused network assets (e.g., to discover unused optical splitter ports and/or unused distribution panel ports). In this manner, the reconciliation device may reconcile the set of inventory records based on a quantity of labor by the technician (e.g., hours) that is significantly less than a quantity of labor associated with manual reconciliation (e.g., days, weeks, etc.).

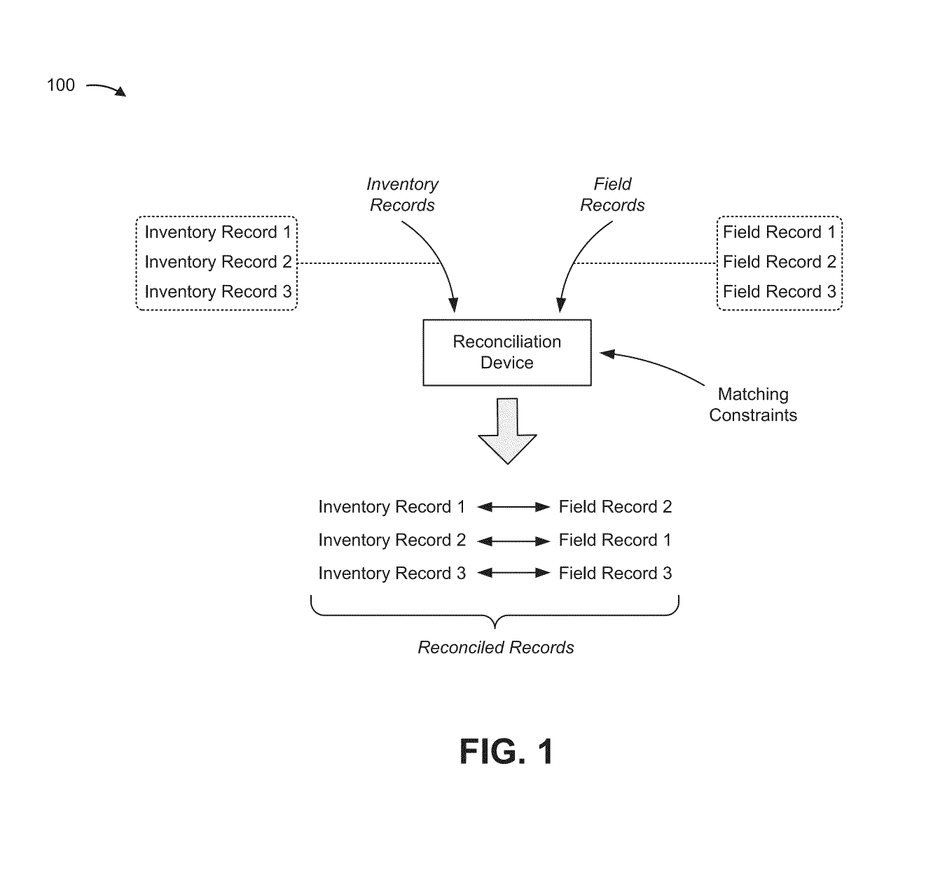

FIG. 1 is a diagram of an overview of example implementation 100 described herein. As shown in FIG. 1, example implementation 100 may include a reconciliation device.

As shown in FIG. 1, the reconciliation device may receive a set of inventory records, including a first inventory record (e.g., Inventory Record 1), a second inventory record (e.g., Inventory Record 2), and a third inventory record (e.g., Inventory Record 3). The inventory records may include information that identifies how one or more devices (e.g., a distribution device) associated with a network are supposedly connected to provide services to customers (e.g., how cross connectors associated with the distribution device are supposedly configured). The reconciliation device may also receive a set of field records, including a first field record (e.g., Field Record 1), a second field record (e.g., Field Record 2), and a third field record (e.g., Field Record 3). The field records may include information that identifies how the one or more devices are actually connected to provide the services to the customers (e.g., how cross connectors associated with the distribution device are actually configured). The reconciliation device may receive a set of matching constraints (e.g., via user input from a system administrator associated with the reconciliation device). A matching constraint may include a condition that, when satisfied, indicates whether an inventory record, of the set of inventory records, likely matches a field record of the set of field records.

As further shown in FIG. 1, the reconciliation device may compare the set of inventory records to the set of field records. Based on the set of matching constraints, the reconciliation device may determine which inventory records match which field records. For example, the reconciliation device may determine that the first inventory record (e.g., Inventory Record 1) matches the second field record (e.g., Field Record 2), that the second inventory record (e.g., Inventory Record 2) matches the first field record (e.g., Field Record 1), that a third inventory record (e.g., Inventory Record 3) matches a third field record (e.g., Field Record 3), and so forth. In this manner the reconciliation device may automatically reconcile the set of inventory records with the set of field records, and may determine when further information is required (e.g., through some manual action) to complete reconciliation.

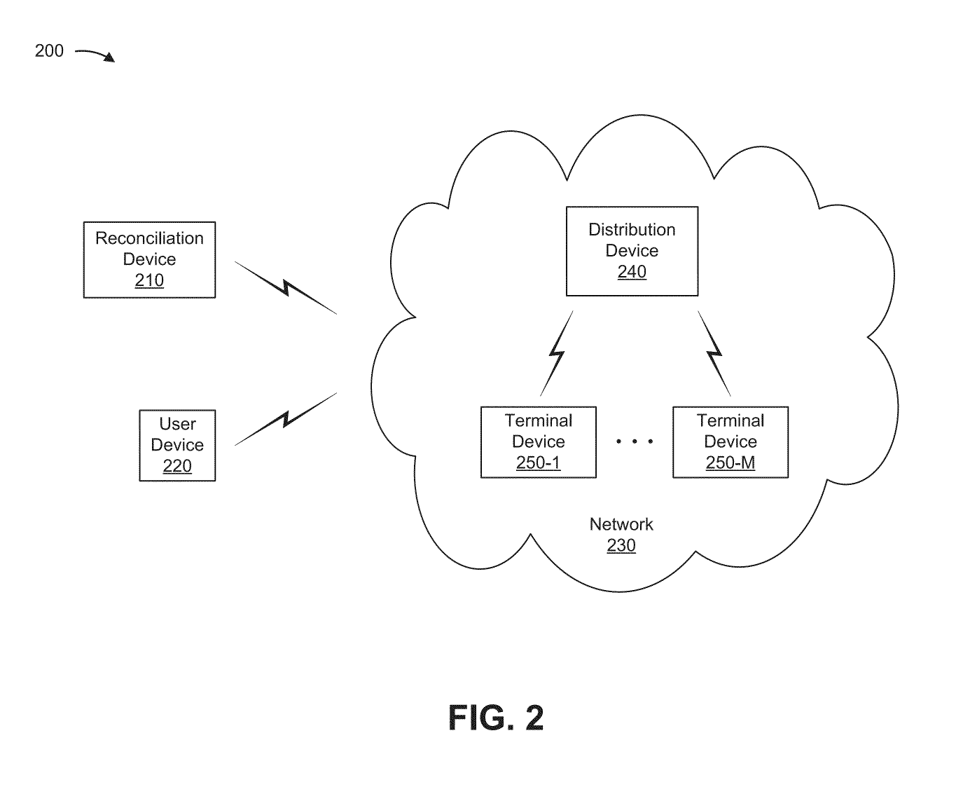

FIG. 2 is a diagram of an example environment 200 in which systems and/or methods described herein may be implemented. As shown in FIG. 2, environment 200 may include a reconciliation device 210, a user device 220, a network 230, a distribution device 240, and terminal devices 250-1 . . . 250-M (M≧1) (hereinafter referred to collectively as “terminal devices 250,” and individually as “terminal device 250”). Devices of environment 200 may interconnect via wired connections, wireless connections, or a combination of wired and wireless connections.

Reconciliation device 210 may include a device capable of reconciling a set of inventory records. For example, reconciliation device 210 may include a computing device, such as a desktop computer, a laptop computer, a tablet computer, a handheld computer, a cellular telephone, a smartphone, a server, or a similar device. Reconciliation device 210 may receive information from and/or transmit information to user device 220, distribution device 240, and/or terminal devices 250.

User device 220 may include a device capable of receiving, processing, and/or transmitting information (e.g., information associated with one or more network devices). For example, user device 220 may include a tablet computer, a handheld computer, a laptop computer, a desktop computer, a smartphone, a cellular telephone, a radiotelephone, or a similar device. User device 220 may receive information from and/or transmit information to reconciliation device 210, distribution device 240, and/or terminal devices 250.

Network 230 may include one or more wired and/or wireless networks. For example, network 230 may include a cellular network, a public land mobile network (“PLMN”), a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network (e.g., a passive optical network (“PON”)), and/or a combination of these or other types of networks.

Network device 230 may include distribution device 240. Distribution device 240 may include a device capable of receiving a signal (e.g., from a service provider) and providing the signal to one or more network devices (e.g., terminal devices 250). For example, distribution device 240 may include a fiber distribution hub, an optical splitter, a fiber distribution panel (e.g., an optical patch panel), or the like. In some implementations, distribution device 240 may include one or more source ports (e.g., associated with an input signal) and/or one or more destination ports (e.g., associated with output signals). Distribution device 240 may be configured to provide the signal (e.g., received from the service provider) to one or more particular network devices (e.g., via one or more cross connectors connecting one or more source ports to one or more destination ports).

Network device 230 may include terminal device 250. Terminal device 250 may include a device capable of receiving a signal (e.g., from distribution device 240) and providing the signal to one or more end points (e.g., customer premises). For example, terminal device 250 may include a fiber distribution terminal. In some implementations, terminal device 250 may include one or more source ports (e.g., associated with an input signal received from distribution device 240) and/or one or more destination ports (e.g., associated with output signals). Terminal device 250 may be configured to provide the input signal to one or more particular network devices, such as an optical network terminal (“ONT”) associated with a customer premises (e.g., via one or more cross connectors connecting one or more source ports to one or more destination ports).

The number of devices and networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

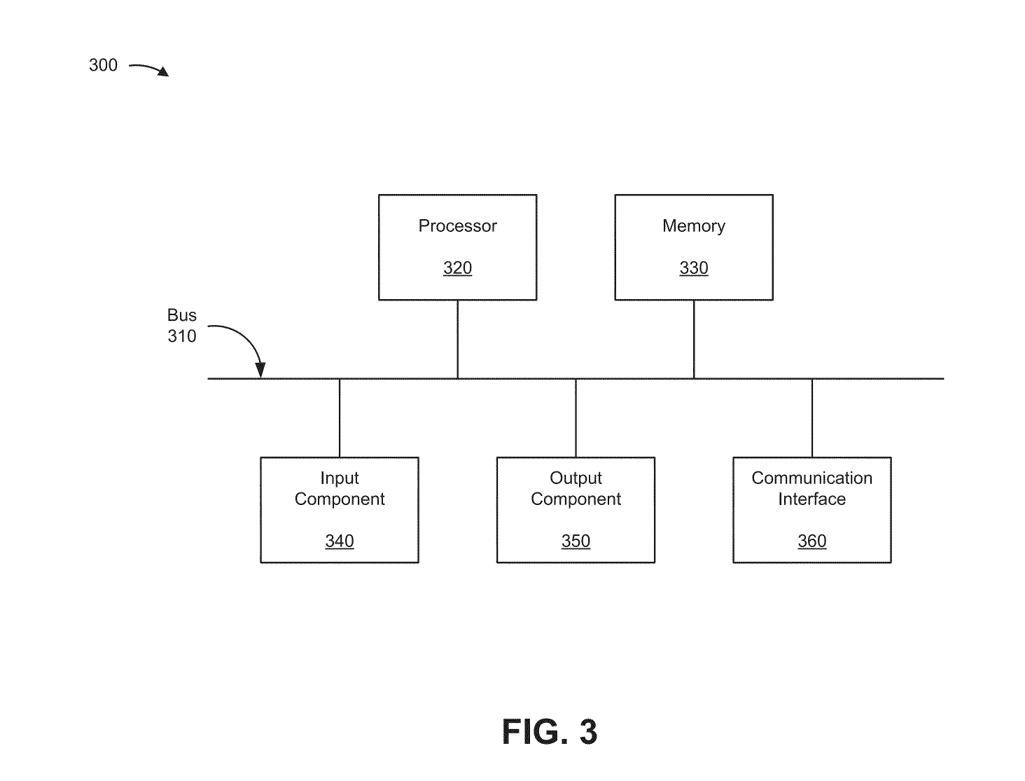

FIG. 3 is a diagram of example components of a device 300. Device 300 may correspond to reconciliation device 210, user device 220, distribution device 240, and/or terminal device 250. Additionally, or alternatively, each of reconciliation device 210, user device 220, distribution device 240, and/or terminal device 250 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit), a microprocessor, and/or any processing component (e.g., a field-programmable gate array (“FPGA”), an application-specific integrated circuit (“ASIC”), etc.) that interprets and/or executes instructions. Memory 330 may include a random access memory (“RAM”), a read only memory (“ROM”), and/or another type of dynamic or static storage device (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (“LEDs”), etc.).

Communication interface 360 may include a transceiver-like component, such as a transceiver and/or a separate receiver and transmitter, that enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3.

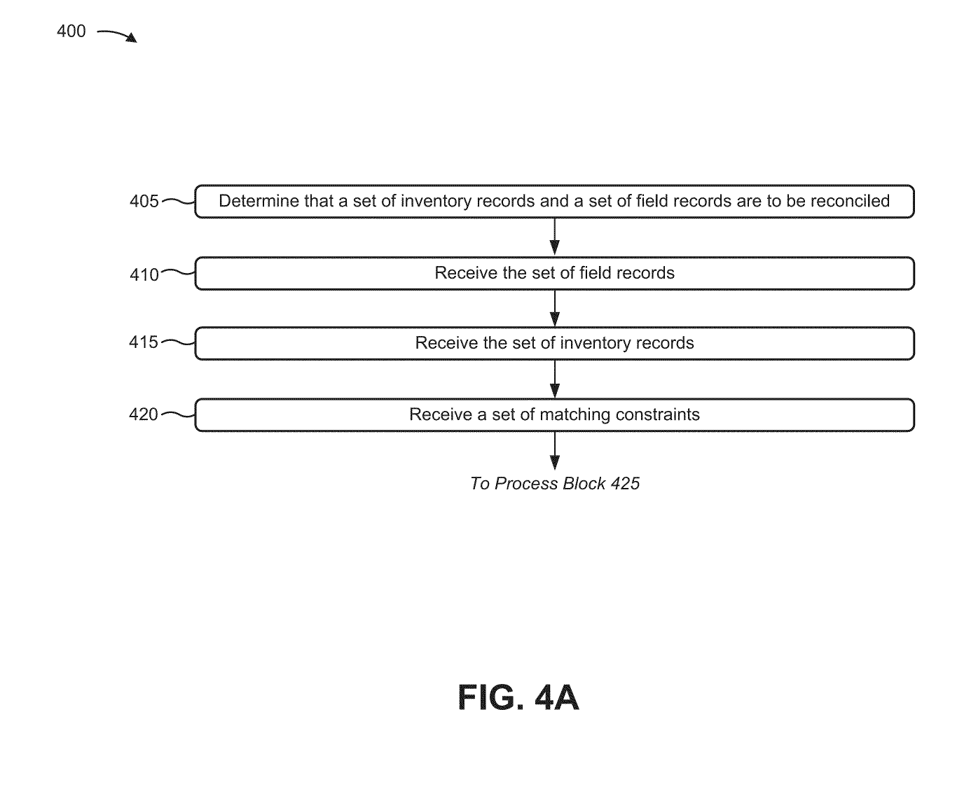

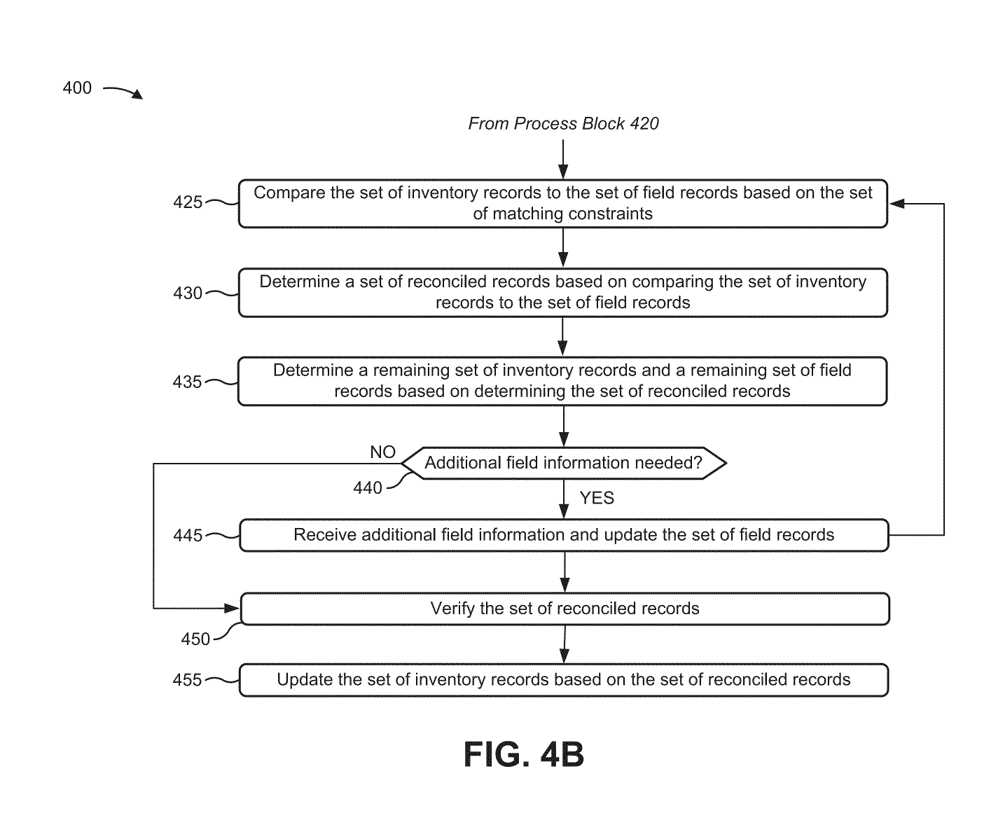

FIGS. 4A-4B are flow charts of an example process 400 for reconciling a set of inventory records with a set of field records associated with a point-to-multipoint network. In some implementations, one or more process blocks of FIGS. 4A-4B may be performed by reconciliation device 210. Additionally, or alternatively, one or more process blocks of FIGS. 4A-4B may be performed by another device or a group of devices separate from or including reconciliation device 210, such as user device 220, distribution device 240, and/or terminal device 250.

As shown in FIG. 4A, process 400 may include determining that a set of inventory records and a set of field records are to be reconciled (block 405). In some implementations, an inventory record, of the set of inventory records, may include information that identifies how one or more devices associated with a network (e.g., network 230) are supposedly connected to provide a service (e.g., a telephone service, an internet service, etc.) to a customer premises (e.g., to a home associated with the customer, an apartment building associated with a customer, an office building associated with the customer, etc.). For example, the inventory record may identify a particular distribution device 240 and/or a particular terminal device 250 used to provide the service to the customer.

In some implementations, distribution device 240 and/or terminal device 250 may include a set of source ports (e.g., identified by a set of source port identifiers) and/or a set of destination ports (e.g., identified by a set of destination port identifiers). The inventory record may identify an association (e.g., a connection) between a particular source port, of the set of source ports, and a particular destination port of the set of destination ports. In some implementations, the source ports and/or the destination ports may be associated with distribution device 240 (e.g., distribution source ports and/or distribution destination ports). Additionally, or alternatively, the source ports and/or the destination ports may be associated with terminal device 250 (e.g., terminal source ports and/or terminal destination ports).

In some implementations, network 230 may include a passive optical network. Distribution device 240 (e.g., a fiber distribution hub) may include an optical splitter that splits an optical signal (e.g., from a service provider) into a set of optical signals associated with a set of source ports (e.g., optical splitter ports). Distribution device 240 may also include a distribution panel associated with a set of destination ports (e.g., distribution panel ports) connected to a set of terminal devices 250 (e.g., fiber distribution terminals). The inventory record may identify which optical splitter port is connected, via a cross connector (e.g., a pigtail), to which distribution panel port. Likewise, terminal device 250 (e.g., a fiber distribution terminal) may include a set of source ports (e.g., associated with an optical signal received from distribution device 240) and a set of distribution ports (e.g., drop terminal ports). In some implementations, a distribution port associated with distribution device 240 (e.g., a distribution panel port) may correspond to a single distribution port associated with terminal device 250 (e.g., a single drop terminal port), and the inventory record may identify which distribution panel port (e.g., associated with distribution device 240) corresponds to which drop terminal port (e.g., associated with terminal device 250). In some implementations, the distribution port associated with distribution device 240 (e.g., the distribution panel port) may correspond to multiple distribution ports associated with terminal device 250 (e.g., multiple drop terminal ports), and the inventory record may identify which source port (e.g., associated with terminal device 250) is connected to which drop terminal port.

In some implementations, the inventory record may include information that identifies an attribute associated with one or more devices of the network. For example, the inventory record may identify a location associated with a network device (e.g., an address, a latitude and longitude, a geocode, etc.), such as distribution device 240 and/or terminal device 250. In some implementations, the set of inventory records may include information that identifies what network devices (e.g., distribution devices 240, terminal devices 250, etc.) are associated with what ports (e.g., source ports, destination ports, etc.). For example, the set of inventory records may include information that identifies that a first destination port is associated with a first terminal device 250-1 at a first location, that a second destination port is associated with a second terminal device 250-2 at a second location, and so forth.

In some implementations, the inventory record may include information associated with a customer (e.g., customer information). For example, the inventory record may include a name associated with the customer, an address associated with the customer, a service provided to the customer (e.g., telephone, internet, etc.), or the like. Additionally, or alternatively, the inventory record may include information that identifies whether the customer is associated with an active account or an inactive account (e.g., whether the customer is currently receiving services).

In some implementations, a field record, of the set of field records, may include information that identifies how the one or more devices associated with the network are actually connected to provide the service to the customer premises. For example, the field record may identify a particular distribution device 240 and/or a particular terminal device 250 actually used to provide the service to the customer premises. In some implementations, the set of field records may identify, with respect to a network device (e.g., distribution device 240, terminal device 250, etc.), how one or more source ports are actually connected to one or more destination ports

In some implementations, reconciliation device 210 may determine that the set of inventory records and the set of field records are to be reconciled based on user input. For example, a user of user device 220 (e.g., a field technician) may provide user input (e.g., via user device 220) indicating that the set of inventory records and the set of field records are to be reconciled. Reconciliation device 210 may determine that the set of inventory records and the set of field records are to be reconciled based on receiving the user input from user device 220.

In some implementations, the user input may include the set of field records. For example, reconciliation device 210 may determine that the set of inventory records and the set of field records are to be reconciled based on receiving the set of field records.

As further shown in FIG. 4A, process 400 may include receiving a set of field records (block 410). For example, reconciliation device 210 may receive the set of field records from user device 220.

In some implementations, reconciliation device 210 may receive the set of field records based on user input. For example, a user of user device 220 (e.g., a field technician) may view distribution device 240, and may input connection information, into user device 220, that identifies how one or more source ports are connected to one or more destination ports. User device 220 may provide the connection information to reconciliation device 210.

In some implementations, the network may include a passive optical network. The user may view distribution device 240 (e.g., a fiber distribution hub) and input connection information (e.g., into user device 220) that identifies which source port (e.g., optical splitter port) is connected, via a cross connector, to which destination port (e.g., distribution panel port). Reconciliation device 210 may receive the connection information from user device 220.

In some implementations, reconciliation device 210 may receive the set of field records based on instructions provided by reconciliation device 210. For example, reconciliation device 210 may provide instructions (e.g., via a notification) to user device 220. The instructions may indicate that a user of user device 220 is to visit a particular distribution device 240. Based on the instructions, the user may visit the particular distribution device 240 and may input the set of field records (e.g., may input information that identifies how the cross connectors, associated with the particular distribution device 240, are configured), via user device 220, to reconciliation device 210. Additionally, or alternatively, the instructions may indicate that the user is to visit a particular terminal device 250. Based on the instructions, the user may visit the particular terminal device 250 and may input additional information associated with the field record (e.g., information that identifies a customer premises associated with the field record), via user device 220, to reconciliation device 210.

As further shown in FIG. 4A, process 400 may include receiving a set of inventory records (block 415). For example, the inventory records may be stored in a data structure associated with reconciliation device 210, and reconciliation device 210 may receive the inventory records by accessing the inventory records in the data structure. Additionally, or alternatively, reconciliation device 210 may receive the inventory records from another device, such as user device 220, a storage device associated with network 230, or the like.

In some implementations, reconciliation device 210 may receive the set of inventory records based on receiving the set of field records. For example, reconciliation device 210 may receive a set of field records associated with a particular distribution device 240 and/or a particular terminal device 250. Based on receiving the set of field records, reconciliation device 210 may access a set of inventory records associated with the set of field records (e.g., a set of inventory records corresponding to the particular distribution device 240 and/or the particular terminal device 250). Additionally, or alternatively, reconciliation device 210 may access a set of inventory records associated with a geographic region (e.g., a neighborhood, a city, etc.), a collection of devices (e.g., a collection of distribution devices 240, a collection of terminal devices 250, etc.), or the like. For example, reconciliation device 210 may access inventory records associated with a particular device (e.g., a particular distribution device 240 associated with the set of field records) as well as inventory records associated with other devices within a geographic region associated with the particular device (e.g., nearby distribution devices 240).

In some implementations, the set of inventory records may be a subset of a total set of inventory records. For example, the set of inventory records may include inventory records associated with a device (e.g., distribution device 240, terminal device 250, etc.), a geographic region, or the like, and may be a subset of the total set of inventory records (e.g., inventory records associated with a network, a service provider, etc.).

As further shown in FIG. 4A, process 400 may include receiving a set of matching constraints (block 420). For example, a user of reconciliation device 210 (e.g., a system administrator) may provide the set of matching constraints, via user input, to reconciliation device 210. Additionally, or alternatively, the set of matching constraints may be stored in a data structure (e.g., associated with reconciliation device 210), and reconciliation device 210 may receive the set of matching constraints by accessing the data structure.

In some implementations, reconciliation device 210 may receive multiple sets of matching constraints (e.g., a first set of matching constraints, a second set of matching constraints, etc.), and may determine to apply a particular set of matching constraints, of the multiple sets of matching constraints, based on information associated with network 230 (e.g., based on a distribution area type). For example, reconciliation device 210 may determine to apply the particular set of matching constraints based on a population density associated with a geographic region served by network 230.

In some implementations, the set of matching constraints may include a set of business rules. For example, a matching constraint, of the set of matching constraints, may include a condition (e.g., defined by a business rule) that, when satisfied, indicates whether an inventory record is likely to match a field record (e.g., whether the inventory record and the field record are associated with the same customer). In some implementations, the matching constraints (e.g., the business rules) may be adjusted (e.g., tuned) based on user input from a user of reconciliation device 210 (e.g., a system administrator).

In some implementations, the satisfaction of a condition, associated with a matching constraint, may indicate that the inventory record likely matches the field record (e.g., that the field record qualifies as a possible match). Additionally, or alternatively, the satisfaction of the condition, associated with the matching constraint, may indicate that the inventory record likely does not match the field record (e.g., that the field record is disqualified from being a possible match). For example, the matching constraint may indicate that the inventory record likely does not match the field record due to ambiguity (e.g., due to the inventory record likely matching multiple field records).

In some implementations, the matching constraint may include a qualifier. A qualifier may include a matching constraint that indicates that the inventory record likely matches the field record (e.g., that qualifies the field record as a possible match). Additionally, or alternatively, the matching constraint may include a disqualifier. A disqualifier may include a matching constraint that indicates that the inventory record likely does not match the field record (e.g., that disqualifies the field record from being a match).

In some implementations, the matching constraint may require that a source port and/or a destination port identified by the inventory record be within a threshold proximity of a source port and/or destination port identified by the field record. For example, the matching constraint may require that a destination port be no more than a maximum quantity (e.g., 0, 2, 4, etc.) of destination ports away from a destination port identified by the field record. In some implementations, the network may include a passive optical network, and the matching constraint may require that the destination port (e.g., a panel distribution port of a fiber distribution hub) identified by the inventory record be within a threshold proximity of the destination port (e.g., the panel distribution port of the fiber distribution hub) identified by the field record.

In some implementations, the matching constraint may require that no other field records, of the set of field records, be associated with a source port and/or a destination port that is closer to a source port and/or a destination port identified by the inventory record than a source port and/or a destination port identified by a particular field record (e.g., that the source port and/or the destination port of the particular field record be closer to the source port and/or the destination port of the inventory record than source ports and/or destination ports associated with the set of field records).

In some implementations, the matching constraint may require that a source port and/or a destination port identified by the field record are associated with an actual device. For example, the matching constraint may require that a destination port be associated with an actual device, such as terminal device 250 (e.g., the matching constraint may require that the destination port does not lead to a dead end).

In some implementations, the matching constraint may require that a particular terminal device 250 identified by the inventory record be within a threshold proximity of a particular terminal device 250 identified by the field record. In some implementations, the threshold proximity may correspond to a physical distance and/or another metric that represents a physical proximity between terminal devices 250.

In some implementations, reconciliation device 210 may determine the proximity based on customer addresses associated with terminal devices 250. For example, first terminal device 250-1 (e.g., identified by an inventory record) may be associated with a first set of addresses (e.g., addresses of customers serviced by first terminal device 250-1 according to one or more inventory records), and second terminal device 250-2 (e.g., identified by a field record) may be associated with a second set of addresses (e.g., address of customers serviced by second terminal device 250-2 according to one or more inventory records). Reconciliation device 210 may determine that first terminal device 250-1 and second terminal device 250-2 are within a threshold proximity of each other based on determining that the first set of addresses are near to the second set of addresses (e.g., that the first set of addresses and the second set of addresses are associated with the same street, that the first set of addresses and the second set of addresses are continuous, etc.).

In some implementations, reconciliation device 210 may determine the proximity based on geographic locations of terminal devices 250 (e.g., a latitude and longitude). For example, reconciliation device 210 may determine that first terminal device 250-1 is near to second terminal device 250-2 based on determining that second terminal device 250-2 is within a distance of first terminal device 250-1 (e.g., within a radius), is closer to first terminal device 250-1 than any other terminal devices 250, or the like.

In some implementations, reconciliation device 210 may determine the proximity based on determining that first terminal device 250-1 and second terminal device 250-2 are associated with a common structure (e.g., a telephone pole, a building, etc.). For example, reconciliation device 210 may determine that first terminal device 250-1 and second terminal device 250-2 are located on a single structure.

In some implementations, reconciliation device 210 may determine a proximity value based on the proximity of terminal devices 250 (e.g., based on geographic locations of terminal devices 250, based on determining that first terminal device 250-1 and second terminal device 250-2 are associated with a common structure, etc.). The proximity value may include a value (e.g., a number) that represents a measure of closeness between first terminal device 250-1 (e.g., associated with an inventory record) and second terminal device 250-2 (e.g., associated with a field record). For example, a first proximity value (e.g., 0) may indicate that first terminal device 250-1 and second terminal device 250-2 are the same terminal device 250 (e.g., that the inventory record and the field record identify the same terminal device 250). A second proximity value (e.g., 1) may indicate that first terminal device 250-1 is a neighbor of second terminal device 250-2 (e.g., that first terminal device 250-1 and second terminal device 250-2 are next to each other). A third proximity value (e.g., 2) may indicate that there is another terminal device 250 between first terminal device 250-1 and second terminal device 250-2. A fourth proximity value (e.g., 3) may indicate that there are multiple terminal devices 250 between first terminal device 250-1 and second terminal device 250-2.

In some implementations, reconciliation device 210 may generate a connected graph of nodes (e.g., representing terminal devices 250) and associated edges (e.g., representing distances between terminal devices 250). Reconciliation device 210 may determine the proximity value between first terminal device 250-1 and second terminal device 250-2 based on determining how many terminal devices 250 lie on a path between first terminal device 250-1 and second terminal device 250-2. In this instance, the proximity value between two nodes may include a shortest path cost between the two nodes.

In some implementations, the network may include a passive optical network, and the matching constraint may require that first terminal device 250-1 (e.g., a first fiber distribution terminal) associated with an inventory record be within a threshold proximity of a second terminal device 250-2 (e.g., a second fiber distribution terminal) associated with a field record. For example, the matching constraint may require that first terminal device 250-1 and second terminal device 250-2 have a proximity value (e.g., 1) that is less than a threshold proximity value (e.g., 2), indicating that first terminal device 250-1 and second terminal device 250-2 be neighboring terminal devices 250 (e.g., that no other terminal devices 250 lie between first terminal device 250-1 and second terminal device 250-2).

As shown in FIG. 4B, process 400 may include comparing the set of inventory records to the set of field records based on the set of matching constraints (block 425). For example, reconciliation device 210 may compare each inventory record, of the set of inventory records, to each field record, of the set of field records. In some implementations, reconciliation device 210 may compare a first inventory record to a first field record, may compare the first inventory record to a second field record, may compare the first inventory record to a third field record, and so forth. Reconciliation device 210 may then compare a second inventory record to the first field record, may compare the second inventory record to the second field record, may compare the second inventory record to the third field record, and so forth.

In some implementations, reconciliation device 210 may compare an inventory record to the set of field records based on a particular matching constraint. For example, reconciliation device 210 may compare a first inventory record to the set of field records (e.g., one field record at a time) based on a first matching constraint (e.g., a matching constraint that requires that a source port, of distribution device 240, identified in the inventory record be the same as a source port identified by the field record). Based on the first matching constraint, reconciliation device 210 may determine which field records qualify as possible matches to the first inventory record (e.g., which field records identify a matching source port). Likewise, reconciliation device 210 may compare the first inventory record to the set of field records based on a second matching constraint (e.g., to determine which field records qualify as possible matches with the first inventory record based on the second matching constraint), based on a third matching constraint (e.g., to determine which field records qualify as possible matches with the first inventory record based on the third matching constraint), and so forth. In this manner, reconciliation device 210 may compare the first inventory record to the set of field records based on the set of matching constraints. Likewise, reconciliation device 210 may compare the remaining inventory records (e.g., a second inventory record, a third inventory record, etc.) to the set of field records based on the set of matching constraints.

In some implementations, reconciliation device 210 may compare the inventory record to the set of field records based on a particular order of matching constraints. For example, reconciliation device 210 may determine the particular order of matching constraints based on a set of matching strengths. A matching strength, of the set of matching strengths, may include an indication of whether satisfaction of a particular matching constraint is more likely to identify a match (e.g., between the inventory record and a field record) than satisfaction of other matching constraints of the set of matching constraints. For example, a first matching constraint (e.g., that requires that the inventory record and the field record be associated with the same terminal device 250) may be associated with a stronger matching strength than a matching strength associated with a second matching constraint (e.g., that requires that the inventory record and field record be associated with nearby terminal devices 250). Based on the matching strengths, reconciliation device 210 may compare the inventory record to the set of field records based on the first matching constraint before comparing the inventory record to the set of field records based on the second matching constraint.

In some implementations, reconciliation device 210 may determine a set of matching metrics associated with a pair (e.g., an inventory record and a field record). The matching metrics may include a quantified measurement of how the inventory record compares to one or more field records as referenced by the set of matching constraints. In some implementations, the matching metrics may include individual matching metrics. The individual matching metrics may identify how a particular inventory record compares to a particular field record. Additionally, or alternatively, the matching metrics may include aggregate matching metrics. The aggregate matching metrics may identify how the particular inventory record compares to two or more field records (e.g., the entire set of field records, a subset of the set of field records, etc.).

In some implementations, reconciliation device 210 may evaluate the matching constraints based on the matching metrics. For example, a matching constraint may include a qualifier and/or a disqualifier. The qualifier may include a comparison that, when evaluated, qualifies the inventory record as a likely match to a field record. The disqualifier may include a comparison that, when evaluated, disqualifies the inventory record as a likely match to the field record. Reconciliation device 210 may evaluate the qualifier and/or disqualifier based on the matching metrics (e.g., based on comparing the matching metrics associated with the inventory record and the field record).

As further shown in FIG. 4B, process 400 may include determining a set of reconciled records based on comparing the set of inventory records to the set of field records (block 430). In some implementations, the set of reconciled records may include inventory records and matching field records (e.g., pairs of inventory records and field records that match).

In some implementations, reconciliation device 210 may determine the set of reconciled records based on the matching metrics. For example, reconciliation device 210 may evaluate the matching metrics for a particular matching constraint (e.g., a particular qualifier associated with the matching metric, a particular disqualifier associated with the matching metric, etc.) to determine whether an inventory record and field record pair likely represents a match. Based on determining that the inventory record and field record pair likely represents a match, reconciliation device 210 may determine that the inventory record and field record pair is a reconciled record.

In some implementations, reconciliation device 210 may determine a reconciled record based on evaluating a qualifier (e.g., associated with a matching constraint) for a set of inventory record and field record pairs. For example, reconciliation device 210 may determine that an inventory record and field record pair is a reconciled record based on determining that the inventory record and field record pair qualifies as a match, and that the inventory record does not qualify any other field record as a match (e.g., that the inventory record qualifies as a match with only the field record and no other field records). Additionally, or alternatively, reconciliation device 210 may determine the reconciled record based on evaluating a disqualifier (e.g., associated with the matching constraint) for the set of inventory records and field record pairs (e.g., may discount the inventory record and field record pair as a match based on evaluating the disqualifier, and/or based on the possibility of multiple inventory records claiming the field record as a match). For example, reconciliation device 210 may determine that the inventory record and field record pair is a reconciled record based on determining that the pair is not disqualified as a match, and that a single inventory record claims a single field record as a match.

As further shown in FIG. 4B, process 400 may include determining a remaining set of inventory records and a remaining set of field records based on determining the set of reconciled records (block 435). In some implementations, reconciliation device 210 may remove the set of reconciled records from the set of inventory records and/or from the set of field records. For example, reconciliation device 210 may determine that an inventory record matches a field record. Based on determining that the inventory record matches the field record, reconciliation device 210 may remove the inventory record from the set of inventory records (e.g., leaving a remaining set of inventory records), and may remove the field record from the set of field records (e.g., leaving a remaining set of field records). In some implementations, reconciliation device 210 may compare a remaining set of inventory records (e.g., absent any reconciled inventory records that have been removed) to a remaining set of field records (e.g., absent any reconciled field records that have been removed) based on the set of matching constraints (e.g., as shown by process block 425). In this manner, reconciliation device 210 may determine a reconciled record and continue through additional iterations of comparing the remaining set of inventory records to the remaining set of field records.

As further shown in FIG. 4B, process 400 may include determining whether additional field information is needed (block 440). In some implementations, the additional field information may include information that permits reconciliation device 210 to reconcile the set of inventory records. For example, the additional field information may include information that identifies whether a field record, of the set of field records, is associated with an active customer (e.g., a customer currently subscribing to a service)

In some implementations, reconciliation device 210 may determine that the additional field information is needed based on determining that there are inventory records and/or field records that are not associated with a match (e.g., based on determining that there are inventory records and/or field records remaining to be reconciled). Additionally, or alternatively, reconciliation device 210 may determine that the additional field information is needed based on determining that there are inventory records and/or field records that are associated with multiple matches.

In some implementations, reconciliation device 210 may determine that the additional field information is needed to verify the set of reconciled records (e.g., to provide a quality check). For example, reconciliation device 210 may determine that the additional field information is needed to verify that an inventory record actually matches the field record.

In some implementations, reconciliation device 210 may determine that the additional field information is not needed. For example, reconciliation device 210 may determine that each inventory record, of the set of inventory records, matches a field record, of the set of field records (e.g., that there are no more inventory records and/or field records to be reconciled). Additionally, or alternatively, reconciliation device 210 may determine that the additional field information is not needed based on determining that the additional field information may not permit reconciliation device 210 to match additional inventory records to field records.

As further shown in FIG. 4B, if additional field information is needed (block 440—YES), process 400 may include receiving additional field information and updating the set of field records (block 445). For example, reconciliation device 210 may send instructions to user device 220 to instruct the user (e.g., the field technician) to perform one or more operations in relation to the network device (e.g., distribution device 240, terminal device 250, etc.) and to provide additional field information based on the one or more operations. In some implementations, the one or more operations may include disrupting a service associated with an inventory record and/or a field record.

In some implementations, disrupting a service may include breaking a connection associated with distribution device 240. For example, based on an instruction provided by reconciliation device 210, the user may break a connection to generate additional field information (e.g., to determine whether the field record is associated with an active customer). Reconciliation device 210 may determine which customer loses service (e.g., which customer premises no longer has internet service, telephone service, etc.). Based on determining which customer loses service, reconciliation device 210 may determine which customer is associated with the connection. For example, reconciliation device 210 may determine that an inventory record, associated with a customer premises, cannot be matched to a particular field record due to determining that the inventory record has a similar likelihood of matching a first field record (e.g., associated with a first distribution port) and a second field record (e.g., associated with a second distribution port). Reconciliation device 210 may instruct a user (e.g., a field technician) to break a connection to the first distribution port and determine whether the customer loses services. Based on determining whether the customer loses service, reconciliation device 210 may determine which of the two possible distribution ports is associated with the customer (e.g., reconciliation device 210 may determine that the customer premises are associated with the first distribution port if the customer premises lose service, or may determine that the customer premises are associated with the second distribution port if the customer premises do not lose service).

In some implementations, the network may include a passive optical network. Reconciliation device 210 may provide information (e.g., to user device 220) that identifies a particular panel distribution port associated with distribution device 240 (e.g., a fiber distribution hub). User device 220 may display the particular panel distribution port to direct the user to remove the cross connector associated with the particular panel distribution port. In some implementations, reconciliation device 210 may determine that the connection is to be reestablished, and may provide information (e.g., to user device 220) to direct the user to replace the cross connector associated with the particular panel distribution port (e.g., after reconciliation device 210 has determine which customers are associated with the disruption in service).

In some implementations, reconciliation device 210 may determine a priority for disrupting a service. For example, reconciliation device 210 may determine that a first cross connector associated with a first source port and/or a first distribution port is to be removed before a second cross connector associated with a second source port and/or a second distribution port is to be removed. In some implementations, reconciliation device 210 may determine the priority based on a quantity of customers who may be associated with a disruption in service (e.g., that disrupting service to a first destination port would affect a smaller quantity of customer premises than disrupting service to a second destination port). Additionally, or alternatively, reconciliation device 210 may determine the priority based on determining which disruption in service would provide the greatest quantity of field records (e.g., that disrupting service to a first destination port would provide a greater quantity of field records than disrupting service to a second destination port).

In some implementations, reconciliation device 210 may receive the additional field information based on a manual inspection of one or more devices of network 230. For example, a user (e.g., of user device 220) may provide the additional field information to user device 220 based on inspecting distribution device 240, terminal device 250 and/or another device of network 230. User device 220 may provide the additional field information to reconciliation device 210.

In some implementations, reconciliation device 210 may update the set of field records based on the additional field information. As shown in FIG. 4B, based on receiving the additional field information, process 400 may return to process block 425. Based on receiving the additional field information, reconciliation device 210 may cause the set of inventory records to become unreconciled (e.g., may determine that a previously matched inventory record and field record pair no longer match). Reconciliation device may re-add the inventory records associated with the set of reconciled records to the set of inventory records, and may re-add the field records associated with the set of reconciled records to the set of field records. Based on the additional field information, reconciliation device 210 may compare the set of inventory records to the set of field records (e.g., including the field records associated with the additional field information) based on the set of matching constraints.

In this manner, reconciliation device 210 may complete additional iterations of comparing the set of inventory records to the set of field records, determining a set of reconciled records, determining a remaining set of inventory records and a remaining set of field records, determining whether additional field information is needed, and receiving the additional field information (e.g., process blocks 425-445), until determining that there are to be no further iterations (e.g., that additional field information is not needed).

As further shown in FIG. 4B, if additional field information is not needed (block 440—NO), then process 400 may include verifying the set of reconciled records (block 450). In some implementations, reconciliation device 210 may verify a reconciled record by breaking a connection associated with distribution device 240 (e.g., by providing an instruction to a field technician via user device 210). For example, reconciliation device 210 may identify a reconciled record that is inactive (e.g., for which a customer premises identified by the reconciled record is no longer subscribing to a service). Reconciliation device 210 may instruct the user (e.g., of user device 220) to break a connection associated with the customer premises, and may verify the reconciled record by determining that no other customer premises lost service.

In some implementations, reconciliation device 210 may determine a source port and/or a destination port that is no longer in use (e.g., that is associated with a reconciled record of an inactive customer), and may instruct the user (e.g., of user device 220) to remove a cross connector associated with the source port and/or destination port. In this manner, reconciliation device 210 may recover unused source ports and/or unused destination ports to permit the source ports and/or the destination ports to be used at a future time (e.g., to connect future customers).

In some implementations, reconciliation device 210 may determine that the reconciled record is in error. For example, based on disrupting a service associated with the reconciled record, reconciliation device 210 may determine that a customer premises (e.g., not identified by the reconciled record) has experienced a disruption in service. Based on determining that the customer premises has experienced a disruption in service, reconciliation device 210 may determine that the reconciled record is incorrect (e.g., that the reconciled record is associated with the wrong customer). In some implementations, based on determining that a reconciled record is in error, reconciliation device 210 may cause the set of inventory records to become unreconciled (e.g., may determine that a previously matched inventory record and field record pair no longer match), and may continue through additional iterations (e.g., may return to process block 425).

As further shown in FIG. 4B, process 400 may include updating the set of inventory records based on the set of reconciled records (block 455). For example, reconciliation device 210 may modify the set of inventory records to correspond to the reconciled records (e.g., to reflect an actual configuration of distribution device 240 and/or terminal device 250 based on reconciling the set of inventory records with the set of field records).

In some implementations, reconciliation device 210 may provide the set of reconciled records to user device 220. Additionally, or alternatively, reconciliation device 210 may provide a notification (e.g., to user device 220) indicating that the reconciliation process is finished (e.g., that there are no further records to reconcile, that the remaining set of inventory records and/or the remaining set of field records cannot be reconciled, etc.). In some implementations, reconciliation device 210 may provide information that identifies any inventory records and/or field records that were not matched (e.g., that are not part of the set of reconciled records).

Although FIGS. 4A-4B show example blocks of process 400, in some implementations, process 400 may include additional blocks, different blocks, fewer blocks, and/or differently arranged blocks than those depicted in FIGS. 4A-4B. Additionally, or alternatively, two or more of the blocks of process 400 may be performed in parallel.

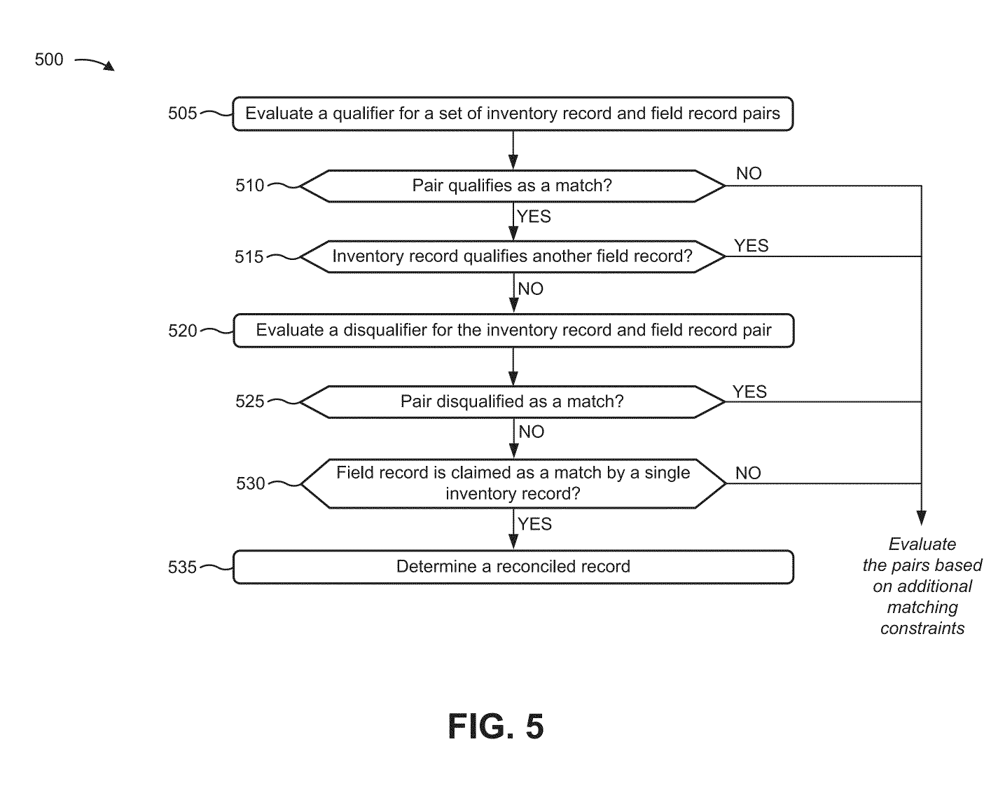

FIG. 5 is a flow chart of an example process 500 relating to process blocks 425 and 430 (FIG. 4B). In example process 500, reconciliation device 210 may compare an inventory record, of the set of inventory records, to a field record, of the set of field records, based on a set of matching constraints. In some implementations, one or more process blocks of FIG. 5 may be performed by reconciliation device 210. Additionally, or alternatively, one or more process blocks of FIG. 5 may be performed by another device or a group of devices separate from or including reconciliation device 210, such as user device 220, distribution device 240, and/or terminal device 250.

As shown in FIG. 5, process 500 may include evaluating a qualifier for a set of inventory record and field record pairs (block 505). For example, reconciliation device 210 may determine the set of inventory record and field record pairs by comparing each inventory record, of the set of inventory records, to each field record of the set of field record. Reconciliation device 210 may evaluate the qualifier for the set of inventory record and field record pairs by determining whether each pair, of the set of inventory record and field record pairs, qualifies as a possible match.

In some implementations, the qualifier may include a matching constraint that, when satisfied, indicates that an inventory record likely matches a field record. In some implementations, the qualifier may include a logic expression that returns a value (e.g., true, false, etc.) based on whether the pair satisfies the matching constraint. For example, the qualifier may include a matching constraint that requires that a source port identified by the inventory record be the same as a source port identified by the field record. Reconciliation device 210 may evaluate the qualifier for an inventory record and field record pair by comparing the source port associated with the inventory record and the source port associated with the field record, and may return a first value (e.g., true) if the ports match, or a second value (e.g., false) if the ports do not match.

As further shown in FIG. 5, process 500 may include determining whether a pair qualifies as a match (block 510). For example, reconciliation device 210 may determine whether the inventory record and field record pair qualifies as a match based on determining that the qualifier is satisfied (e.g., that a condition associated with the matching constraint is satisfied). In some implementations, if no inventory record and field record pair qualifies as possible matches (block 510—NO), reconciliation device 210 may evaluate the set of inventory record and field record pairs based on additional matching constraints.

As further shown in FIG. 5, if a pair qualifies as a match (block 510—YES), process 500 may include determining whether the inventory record qualifies another field record (block 515). For example, reconciliation device 210 may determine whether the inventory record qualifies as a match with one or more additional field records.

In some implementations, reconciliation device 210 may determine whether the inventory record qualifies another field record based on determining a set of qualified pairs. For example, reconciliation device 210 may determine the set of qualified pairs based on determining which pairs, of the set of inventory record and field record pairs, qualify as a match (e.g., satisfy a condition associated with the matching constraint). Based on the set of qualified pairs, reconciliation device 210 may determine whether the inventory record is associated with more than one pair. In some implementations, if the inventory record qualifies more than one field record (block 515—YES), reconciliation device 210 may evaluate the set of inventory record and field record pairs based on additional matching constraints.

As further shown in FIG. 5, if the inventory record does not qualify another field record (block 515—NO), process 500 may include evaluating a disqualifier for the inventory record and field record pair (block 520). In some implementations, the disqualifier may include a matching constraint that, when satisfied, indicates that an inventory record likely does not match a field record. In some implementations, the disqualifier may include a logic expression that returns a value (e.g., true, false, etc.) based on whether the pair satisfies the matching constraint. For example, the disqualifier may include a matching constraint that requires that a destination port associated with the inventory record and/or field record be associated with a non-existing network device (e.g., a non-existing terminal device 250). Reconciliation device 210 may evaluate the disqualifier for the inventory record and field record pair by determining whether the destination port identified by the pair is associated with a non-existing network device.

As further shown in FIG. 5, process 500 may include determining whether the pair is disqualified as a match (block 525). For example, reconciliation device 210 may determine whether the inventory record and field record pair is disqualified as a match based on determining that the disqualifier is satisfied (e.g., that a condition associated with the matching constraint is satisfied). In some implementations, if the inventory and field record pair is disqualified as a match (block 525—YES), reconciliation device 210 may evaluate the set of inventory record and field record pairs based on additional matching constraints. In some implementations, if the inventory and field record pair is disqualified as a match, reconciliation device 210 may not reconcile the inventory and field record pair regardless of an existence of additional qualifiers (e.g., reconciliation device 210 may determine that the inventory record does not match the field record).

As further shown in FIG. 5, if the pair is not disqualified as a match (block 525—NO) process 500 may include determining whether the field record is claimed as a match by a single inventory record (block 530). For example, reconciliation device 210 may determine whether the field record (e.g., associated with the inventory record and field record pair) is claimed as a match by another inventory record (e.g., whether the field record qualifies as a match with one or more additional inventory records).

In some implementations, reconciliation device 210 may determine whether the field record is claimed by the inventory record as a match based on the set of qualified pairs. For example, reconciliation device 210 may determine whether the field record is associated with more than one pair. In some implementations, if the field record is claimed by more than one inventory record (block 530—NO), reconciliation device 210 may evaluate the set of inventory record and field record pairs based on additional matching constraints.

As further shown in FIG. 5, if the field record claims the inventory record as a match (block 530—YES), process 500 may include determining a reconciled record (block 535). For example, reconciliation device 210 may determine that the inventory record and the field record are to be associated as a reconciled record (e.g., a reconciled inventory record and matching reconciled field record). In this manner, reconciliation device 210 may determine that an inventory record and a field record may be confirmed as a match (e.g., based on determining that the pair qualifies as a match, that the inventory record does not qualify any other field record as a match, that the pair is not disqualified as a match, and that the field record is claimed by only the inventory record as a match). In some implementations, reconciliation device 210 may remove the inventory record and field record, of the matching pair, from the set of inventory records and the set of field records to form a set of remaining inventory records and a set of remaining field records.

In some implementations, reconciliation device 210 may complete additional iterations of process 500 based on the set of remaining inventory records and the set of remaining field records. For example, reconciliation device 210 may complete process 500 for a first matching constraint (e.g., associated with a first qualifier and a first disqualifier). Likewise, reconciliation device 210 may complete process 500 for a second matching constraint (e.g., associated with a second qualifier and a second disqualifier), a third matching constraint (e.g., associated with a third qualifier and a third disqualifier), and so forth, until determining a reconciled record (e.g., an inventory record and matching field record). In some implementations, based on determining the reconciled record, reconciliation device 210 may restart process 500 for the set of remaining inventory record and remaining field record pairs, starting with the first matching constraint and continuing to the second matching constraint, the third matching constraint, and so forth, until completing process 500 for all of the matching constraints (e.g., of the set of matching constraints), or until determining an additional reconciled record. In this manner, reconciliation device 210 may complete additional iterations of process 500 to identify additional reconciled records.

Although FIG. 5 shows example blocks of process 500, in some implementations, process 500 may include additional blocks, different blocks, fewer blocks, and/or differently arranged blocks than those depicted in FIG. 5. Additionally, or alternatively, two or more of the blocks of process 500 may be performed in parallel.

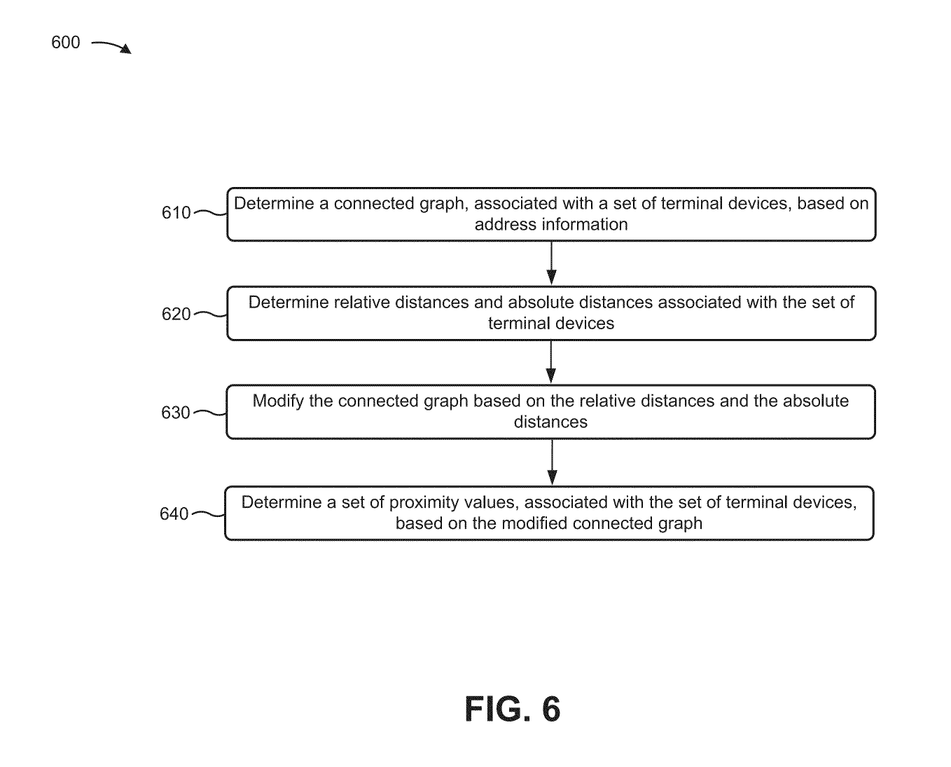

FIG. 6 is a flow chart of another example process 600 relating to process 400 (FIGS. 4A-4B). In example process 600, reconciliation device 210 may determine a set of proximity values based on determining which terminal devices 250, of the set of terminal devices 250, are neighbors. In some implementations, one or more process blocks of FIG. 6 may be performed by reconciliation device 210. Additionally, or alternatively, one or more process blocks of FIG. 6 may be performed by another device or a group of devices separate from or including reconciliation device 210, such as user device 220, distribution device 240, and/or terminal device 250.

As shown in FIG. 6, process 600 may include determining a connected graph, associated with a set of terminal devices, based on address information (block 610). For example, reconciliation device 210 may determine the connected graph based on addresses of customers served by the set of terminal devices 250.

In some implementations, the connected graph may include a representation of locations of terminal devices 250 (e.g., associated with a distribution area served by distribution device 240). For example, the set of terminal devices 250 may be represented as a set of nodes in the connected graph. Two or more nodes may be connected by one or more edges, indicating that the corresponding terminal devices 250 are neighbors.

In some implementations, reconciliation device 210 may determine the connected graph based on address information associated with the set of terminal devices 250 (e.g., as identified by the set of inventory records). The address information may include a set of addresses associated with the set of terminal devices 250. For example, a particular terminal device 250 may serve a set of addresses (e.g., may be connected to a set of customer premises). The address information may include street names and house numbers (e.g., building numbers, apartment numbers, suite numbers, etc.) that identify the set of customer premises. In some implementations, terminal device 250 may be associated with one or more street names within the distribution area.

In some implementations, reconciliation device 210 may determine a street range associated with a particular terminal device 250. The street range may include a range of house numbers associated with a particular street served by the particular terminal device 250. In some implementations, the street range may range from a low house number (e.g., a house number that is less than all other house numbers on a particular street associated with the particular terminal device 250) to a high house number (e.g., a house number that is greater than all other house numbers on the particular street associated with the particular terminal device 250). For example, terminal device 250 may connect to a first house associated with a first address (e.g., 101 Main Street), a second house associated with a second address (e.g., 103 Main Street), and a third house associated with a third address (e.g., 105 Main Street). In this instance, the street range may include a range from the lowest house number (e.g., 101) to the highest house number (e.g., 105) associated with the street (e.g., Main Street).

In some implementations, reconciliation device 210 may determine that a first terminal device 250-1 and a second terminal device 250-2 are neighbors (e.g., that a node associated with first terminal device 250-1 is connected to a node associated with second terminal device 250-2 in the connected graph) based on determining that first terminal device 250-1 and second terminal device 250-2 have adjacent street ranges. For example, first terminal device 250-1 may be associated with a first street range (e.g., 5 to 11) for a particular street (e.g., Park Street), and second terminal device 250-2 may be associated with a second street range (e.g., 13 to 21) for the same street. Based on determining that the first street range is adjacent to the second street range (e.g., based on determining that the first street range ends at a house number of 11 and that the second street range begins at a next consecutive odd house number of 13), reconciliation device 210 may determine that first terminal device 250-1 and second terminal device 250-2 are neighbors (e.g., that a node associated with first terminal device 250-1 and a node associated with second terminal device 250-2 are connected).

In some implementations, reconciliation device 210 may determine that two street ranges (e.g., associated with a street) are adjacent based on a separation between the two street ranges. The separation may include a difference between the two street ranges (e.g., a difference between a highest house number associated with a first street range and a lowest house number associated with a second street range). For example, first terminal device 250-1 may be associated with a first street range (e.g., 2 to 12), and second terminal device 250-1 may be associated with a second street range (e.g., 18 to 32). Reconciliation device 210 may determine the difference between the highest house number of the first street range (e.g., 12) and the lowest house number of the second range (e.g., 18) to determine the separation (e.g., 6) between the first street range and the second street range.

In some implementations, reconciliation device 210 may determine that a first street range and a second street range are adjacent based on determining that the separation between the first street range and the second street range are less than a threshold separation. Additionally, or alternatively, reconciliation device 210 may determine that that the first street range and the second street range are adjacent based on determining that the separation between the first street range and the second street range is less than a separation between the first street range and other street ranges (e.g., a third street range associated with a third terminal device 210-3, a fourth street range associated with a fourth terminal device 210-4, etc.).

In some implementations, reconciliation device 210 may determine that first terminal device 250-1 and second terminal device 250-2 are neighbors (e.g., that a node associated with first terminal device 250-1 is connected to a node associated with second terminal device 250-2 in the connected graph) based on determining that first terminal device 250-1 and second terminal device 250-2 are associated with overlapping street ranges. For example, first terminal device 250-1 may be associated with a first street range (e.g., 30 to 54) for a particular street (e.g., Smith Street), and second terminal device 250-2 may be associated with a second street range (e.g., 46 to 60) for the same street. Based on determining that the first street range overlaps the second street range (e.g., based on determining that the first street range ends at a house number of 54 that falls within the second street range of 56 to 60), reconciliation device 210 may determine that first terminal device 250-1 and second terminal device 250-2 are neighbors (e.g., that a node associated with first terminal device 250-1 and a node associated with second terminal device 250-2 are connected).

In this manner, reconciliation device 210 may determine the connected graph based on determining which terminal devices 250, of the set of terminal devices 250, are neighbors (e.g., based on adjacent street ranges, overlapping street ranges, etc.).

As further shown in FIG. 6, process 600 may include determining relative distances and absolute distances associated with the set of terminal devices (block 620). In some implementations, an absolute distance associated with a first terminal device 250-1 and a second terminal device 250-2 may include a quantity of distance between first terminal device 250-1 and second terminal device 250-2 (e.g., based on locations of first terminal device 250-1 and second terminal device 250-2 associated with the set of inventory records). For example, first terminal device 250-1 may be associated with a first location (e.g., corresponding to a first latitude and a first longitude), and second terminal device 250-2 may be associated with a second location (e.g., corresponding to a second latitude and a second longitude). Reconciliation device 210 may determine the absolute distance between first terminal device 250-1 and second terminal device 250-2 based on the first location and the second location.

In some implementations, a relative distance associated with first terminal device 250-1 and second terminal devices 250-2 may include a measure of a how a distance between first terminal device 250-1 and second terminal device 250-2 compares to a baseline distribution of distances associated with a set of neighboring terminal devices 250 (e.g., all neighboring terminal devices 250 within a distribution area associated with distribution device 240). For example, reconciliation device 210 may determine an absolute distance between first terminal device 250-1 and second terminal device 250-2. The relative distance (e.g., associated with first terminal device 250-1 and second terminal device 250-2) may include a percentile rank of the absolute distance within the baseline distribution (e.g., 20%, 70%, etc.).

In some implementations, a particular relative distance (e.g., 60%) may indicate that a portion (e.g., 59%) of distances among the set of neighboring terminal devices 250 is less than the absolute distance, and that a portion (e.g., 39%) of distances among the set of neighboring terminal devices 250 is greater than the absolute distance.

In some implementations, a particular relative distance may correspond to different actual distances for different distribution areas (e.g., for different sets of terminal devices 250 associated with different distribution devices 240). For example, a first distribution area may be associated with a first set of neighboring terminal devices 250 that, on average, are farther apart than a second set of neighboring terminal devices 250 associated with a second distribution area (e.g., the first distribution area may be less densely filled with terminal devices 250 than the second distribution area). A particular relative distance (e.g., 90%) may correspond to a first actual distance (e.g., 500 meters) in the first distribution area that differs from a second actual distance (e.g., 50 meters) in the second distribution area.

As further shown in FIG. 6, process 600 may include modifying the connected graph based on the relative distances and the absolute distances (block 630). For example, reconciliation device 210 may modify the connected graph based on determining additional connections between nodes.

In some implementations, reconciliation device 210 may modify the connected graph to correct for deficiencies (e.g., instances when the connected graph does not reflect that two or more terminal devices 250 are actually neighbors). For example, reconciliation device 210 may determine a connected graph (e.g., based on address information) that includes deficiencies, such as isolated nodes, isolated segments of nodes, or the like. Reconciliation device 210 may modify the graph to connect the isolated nodes and/or isolated segments to other nodes and/or segments in the connected to graph.

In some implementations, reconciliation device 210 may modify the connected graph by connecting a particular node (e.g., an isolated node) to other nodes within a threshold distance of the particular node (e.g., may determine that a particular terminal device 250 is neighbors with other terminal devices 250 within the threshold distance). In some implementations, the threshold distance may be associated with a relative distance, an actual distance, etc.

In some implementations, the threshold distance may include a distance (e.g., an absolute distance) from the particular node to a nearest node plus a headroom distance. For example, based on a distance from the particular node to the nearest node (e.g., 50 meters) plus a headroom distance (e.g., 10 meters), reconciliation device 210 may determine the threshold distance (e.g., 60 meters). Reconciliation device 210 may connect the particular node to all other nodes within the threshold distance (e.g., within a 60 meter radius of the particular node).

In some implementations, reconciliation device 210 may modify the connected graph based on destination ports associated with distribution device 240. For example, reconciliation device 210 may determine that a first terminal device 250-1 is associated with a first destination port of distribution device 240, and that a second terminal device 250-2 is associated with a second destination port of distribution device 240. Based on determining that the first destination port is near to the second destination port (e.g., that the first destination port is adjacent to the second destination port, that the first destination port and the second destination port are in sequential order, etc.), reconciliation device 210 may determine that first terminal device 250-1 and second terminal device 250-2 are neighbors (e.g., that a node associated with first terminal device 250-1 is connected to a node associated with second terminal device 250-2).

In some implementations, reconciliation device 210 may modify the connected graph to connect two or more segments of nodes (e.g., isolated segments of nodes). For example, reconciliation device 210 may identify a first segment of nodes and a second segment of nodes. Reconciliation device 210 may determine a first node in the first segment that is closest to the second segment of nodes (e.g., closer to the second segment of nodes than any other node associated with the first segment of nodes). In some implementations, reconciliation device 210 may connect the first segment of nodes to the second segment of nodes by connecting the first node to any other nodes (e.g., of the second segment of nodes) within a threshold distance (e.g., associated with a relative distance, an actual distance, etc.). In some implementations, the threshold distance may include a distance between the first node (e.g., of the first segment of nodes) and a second node (e.g., of the second segment of nodes) plus a headroom distance.

In some implementations, reconciliation device 210 may modify the connected graph based on determining that one or more nodes (e.g., corresponding to one or more terminal devices 250) are associated with common structure (e.g., a telephone pole, a building, etc.). For example, reconciliation device 210 may determine that a first terminal device 250-1 and a second terminal device 250-2 are located on the common structure. Based on determining that first terminal device 250-1 and second terminal device 250-2 are located on the common structure, reconciliation device 210 may determine that first terminal device 250-1 and second terminal device 250-2 are neighbors (e.g., may connect a first node associated with first terminal device 250-1 to a second node associated with second terminal device 250-2). Additionally, or alternatively, reconciliation device 210 may determine that first terminal device 250-1 is also neighbors with other terminal devices 250 associated with second terminal device 250-2 (e.g., as neighbors), and may determine that second terminal device 250-2 is also neighbors with other terminal devices 250 associated with first terminal devices 250-1 (e.g., as neighbors).

As further shown in FIG. 6, process 600 may include determining a set of proximity values, associated with the set of terminal devices, based on the modified connected graph (block 640). For example, reconciliation device 210 may determine the set of proximity values based on the modified connected graph (e.g., based on determining which terminal devices 250, of the set of terminal devices 250, are neighbors).

In some implementations, the proximity value may include a value (e.g., a number) that represents a measure of closeness between a first node (e.g., corresponding to a first terminal device 250-1) and a second node (e.g., corresponding to a second terminal device 250-2) associated with the modified connected graph. In some implementations, an edge in the modified connected graph (e.g., connecting two nodes) may be associated with a weight. For example, each edge in the modified connected graph may be associated with a uniform weight (e.g., 1). The proximity value may represent a shortest path cost between the first node and the second node based on the weights (e.g., the proximity value may include a sum of weights associated with one or more edges along the shortest path between the first node and the second node).

Although FIG. 6 shows example blocks of process 600, in some implementations, process 600 may include additional blocks, different blocks, fewer blocks, and/or differently arranged blocks than those depicted in FIG. 6. Additionally, or alternatively, two or more of the blocks of process 600 may be performed in parallel.

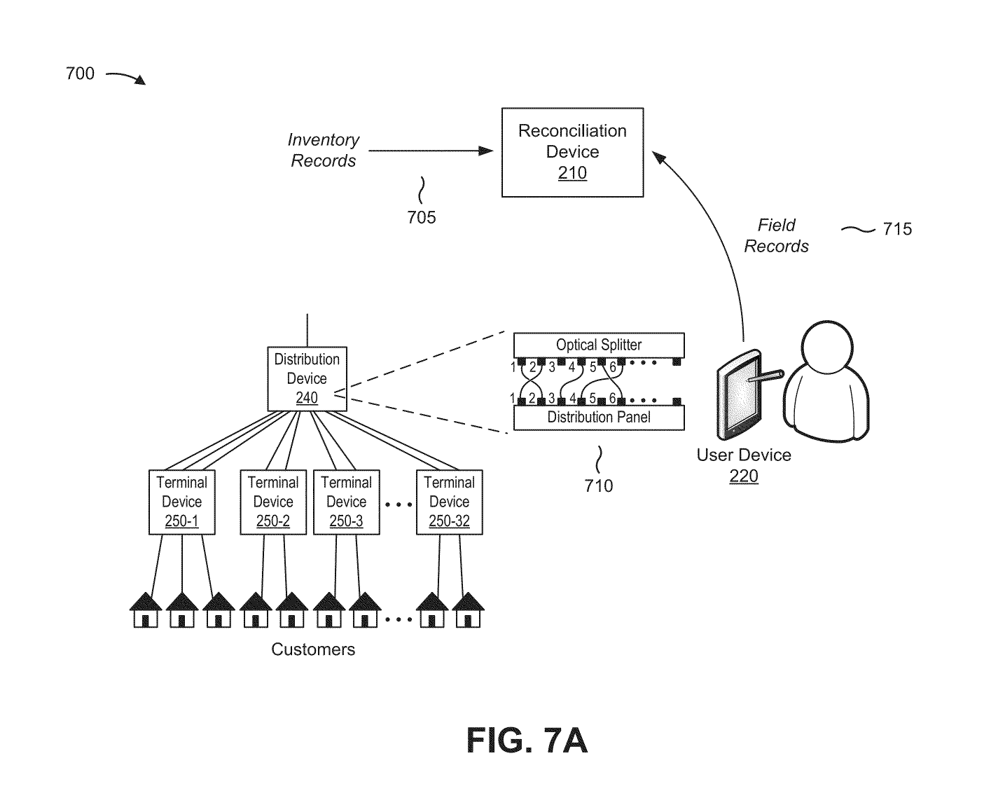

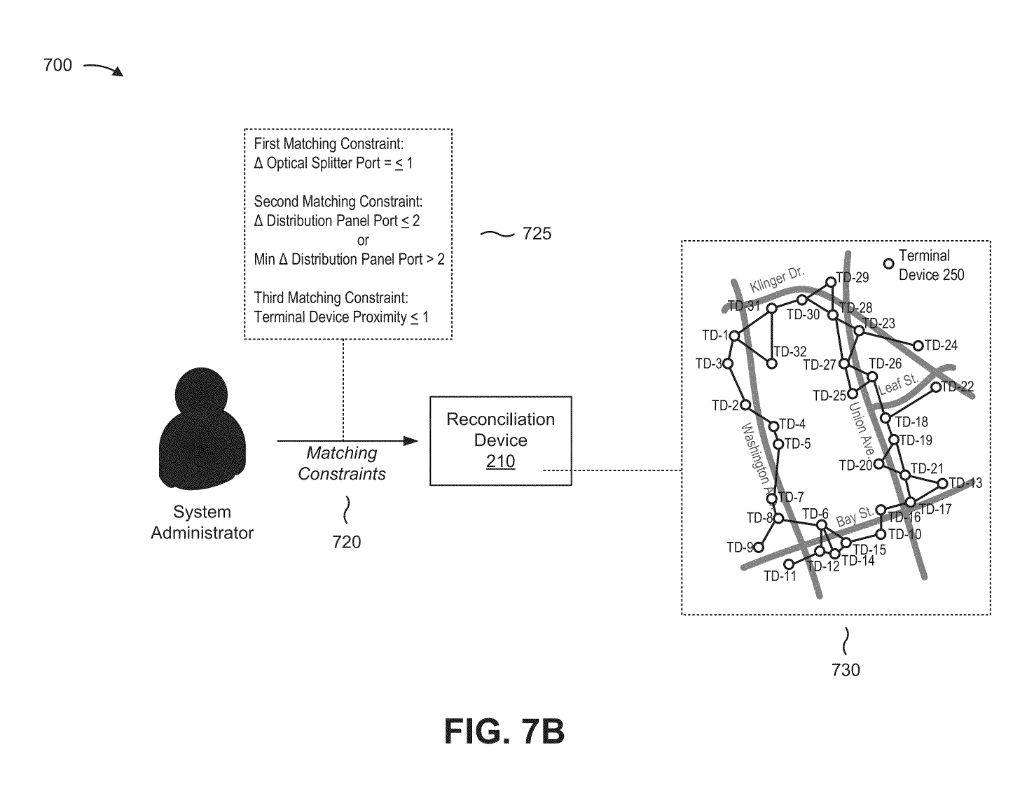

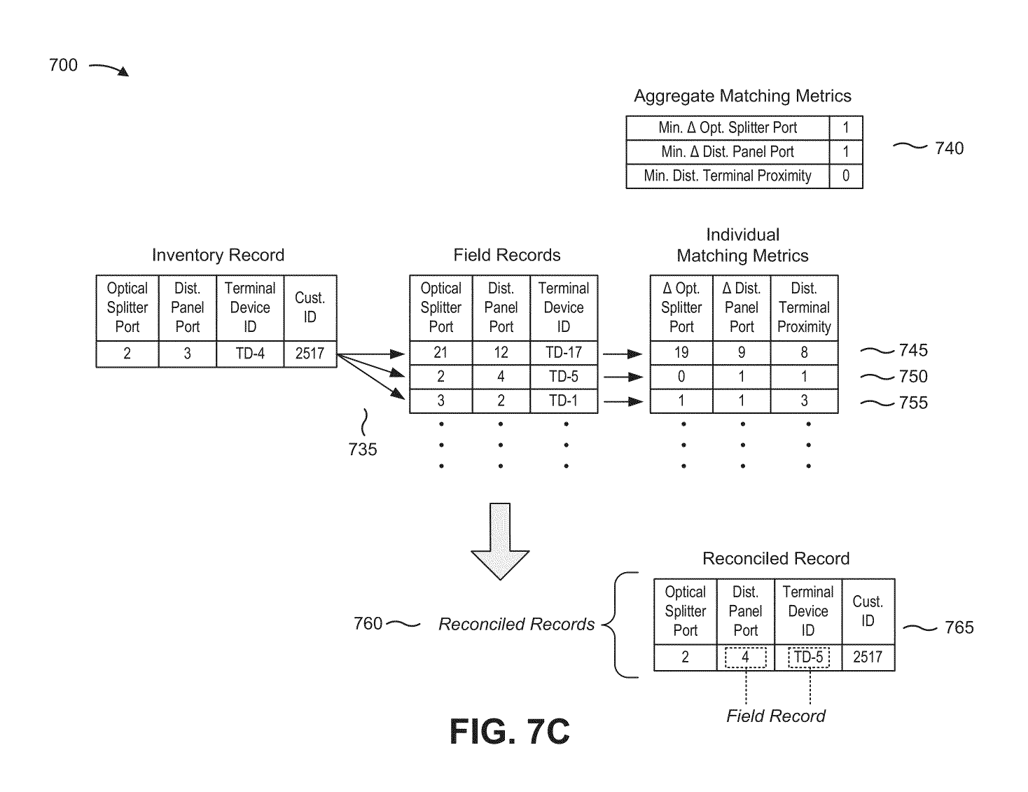

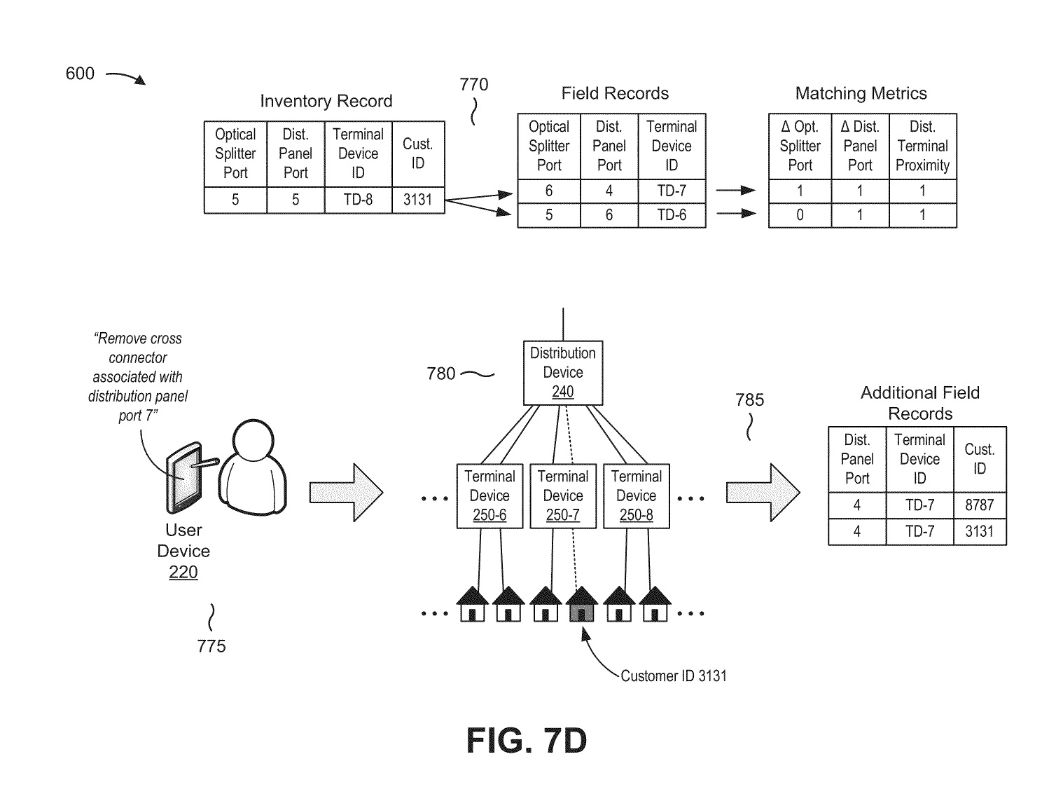

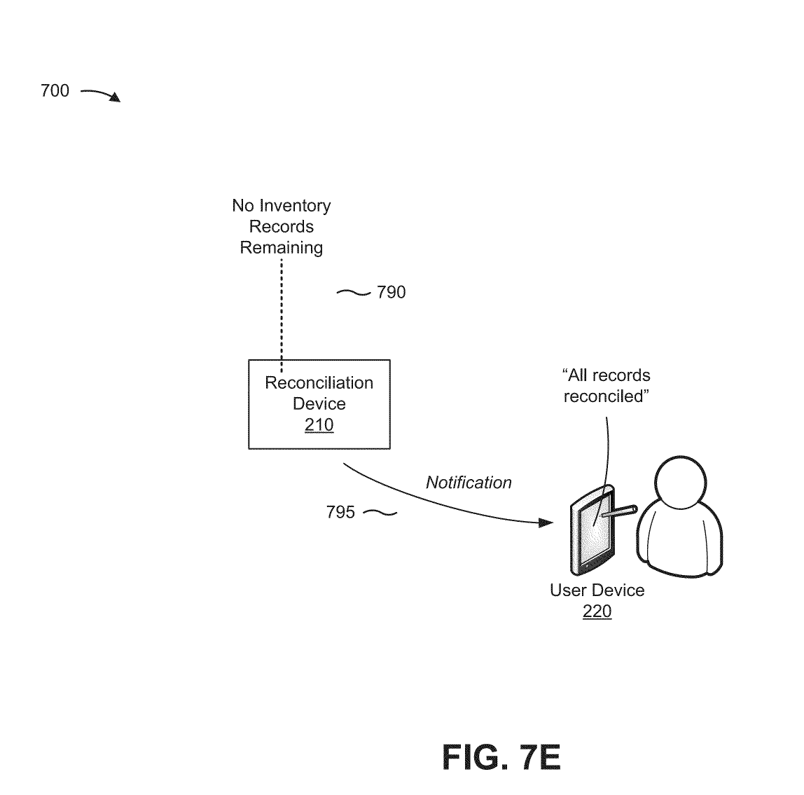

FIGS. 7A-7E are diagrams of an example implementation 700 relating to process 400 (FIG. 4). In example implementation 700, a set of customers (e.g., associated with houses) may receive services via a fiber optic network. Assume that the fiber optic network includes distribution device 240 (e.g., a fiber distribution hub) connected to a set of 32 terminal devices 250. Distribution device 240 may include an optical splitter (with a set of optical splitter ports) and a distribution panel (e.g., with a set of distribution panel ports).

As shown in FIG. 7A, and by reference number 705, reconciliation device 210 may receive a set of inventory records. The inventory records may include information that identifies how distribution device 240 is connected to the set of terminal devices 250, such as which optical splitter ports are connected to which distribution panel ports (e.g., distribution panel ports leading to the set of terminal devices 250). The inventory records may also include information that identifies the set of customers (e.g., customer IDs, customer names, addresses, etc.), information that identifies the location of the set of terminal devices 250 (e.g., latitude and longitude), or the like.

As shown by reference number 710, a user of user device 220 (e.g., a field technician) may visit distribution device 240, and may view a set of cross connectors associated with the set of optical splitter ports and the set of distribution panel ports. User device 220 may receive, via user input from the field technician, information that identifies which optical splitter ports are connected (e.g., via the cross connectors) to which distribution panel ports (e.g., user device 220 may receive the set of field records). As shown by reference number 715, user device 220 may provide the set of field records to reconciliation device 210.

As shown in FIG. 7B, and by reference number 720, reconciliation device 210 may receive a set of matching constraints from user device 220. The matching constraints may be determined based on user input (e.g., based on parameters provided by a system administrator). As shown by reference number 725, assume that the matching constraints include a first matching constraint, a second matching constraint, and a third matching constraint. The first matching constraint may require that the difference between an optical splitter port identified by an inventory record and an optical splitter port identified by a field record be less than or equal to 1 (e.g., that the inventory record and the field record have neighboring splitter ports). The second matching constraint may require that the difference between a distribution panel port identified in an inventory record and a distribution panel port identified in the field record differ by no more than two distribution panel ports, or that the minimum difference between the distribution panel port identified by the first inventory record and the distribution panel ports identified by the set of field records is less than 2. The third matching constraint may require that a terminal device 250 identified in the inventory record (e.g., associated with a distribution panel port identified by the inventory record) and a terminal device 250 identified in the field record (e.g., associated with a distribution panel port identified by the field record) have a proximity value less than or equal to 1 (e.g., that the terminal device 250 identified by the inventory record and the terminal device 250 identified by the field record are neighbors).

As shown by reference number 730, reconciliation device 210 may determine a connected graph of locations associated with the set of terminal devices 250 (e.g., TD-1 through TD-32). Reconciliation device 210 may determine the locations of the set of terminal devices 250 based on addresses (e.g., customer addresses), geographic locations of terminal devices 250, and/or common structures shared by terminal devices 250. Based on the connected graph, reconciliation device 210 may determine a set of proximity values associated with the set of terminal devices 250.

As shown in FIG. 7C, and by reference number 735, reconciliation device 210 may compare the set of inventory records to the set of field records based on the set of matching constraints. Reconciliation device 210 may compare a first inventory record to the set of field records (e.g., a first field record, a second field record, a third field record, etc.). The first field record may identify an optical splitter port (e.g., 2), a distribution panel port (e.g., 3), a terminal device identifier (e.g., TD-4) and a customer ID (e.g., 2514). The first field record may identify an optical splitter port (e.g., 21), a distribution panel port (e.g., 12), and a terminal device identifier (e.g., TD-17). The second field record may identify an optical splitter port (e.g., 2), a distribution panel port (e.g., 4), and a terminal device identifier (e.g., TD-5). The third field record may identify an optical splitter port (e.g., 3), a distribution panel port (e.g., 2), and a terminal device identifier (e.g., TD-1).

As shown by reference 740, reconciliation device 210 may determine a set of aggregate matching metrics based on comparing the inventory record to the set of field records (e.g., the entire set of field records). Reconciliation device 210 may determine that the minimum difference between the optical splitter port identified by the first inventory record and the optical splitter ports identified by the set of field records is 1. Reconciliation device 210 may determine that the minimum difference between the distribution panel port identified by the first inventory record and the distribution panel ports identified by the set of field records is 1. Reconciliation device 210 may determine that the minimum proximity value between a terminal device 250 identified by the first inventory record and the proximity values associated with terminal devices 250 identified by the set of field records is 0.

As shown by reference number 745, reconciliation device 210 may determine a set of individual matching metrics based on comparing the first inventory record to the set of field records. Reconciliation device 210 may determine that the difference between the optical splitter port identified by the first inventory record (e.g., 2) and the optical splitter port identified by the first field record (e.g., 21) is 19 and thus does not satisfy the first matching constraint (e.g., which requires that difference be less than or equal to 1). Reconciliation device 210 may determine that the difference between the distribution panel port identified by the first inventory record (e.g., 3) and the distribution panel port identified by the first field record (e.g., 12) is 9 and thus does not satisfy the second matching constraint (e.g., which requires that the difference be less than or equal to 2). Reconciliation device 210 may also determine that the minimum difference between the distribution panel port identified by the first inventory record and the distribution panel ports identified by the set of field records is 1 and thus also does not satisfy the second matching constraint (e.g., which requires that the minimum difference be greater than 2). Reconciliation device 210 may determine that a proximity value between a terminal device 250 identified by the first inventory record (e.g., TD-4) and a terminal device 250 identified by the first field record (e.g., TD-17) have a proximity value of 8, indicating that there may be multiple terminal devices 250 between the terminal device 250 associated with the first inventory record and the inventory device 250 associated with the first field record, and thus does not satisfy the third matching constraint (e.g., which requires that the terminal devices 250 be neighboring terminal devices 250). Based on the set of individual matching metrics, reconciliation device 210 may determine that the first field record does not match the first inventory record.

As shown by reference number 750, reconciliation device 210 may determine that the difference between the optical splitter port identified by the first inventory record (e.g., 2) and the optical splitter port identified by the second field record (e.g., 2) is 0 and thus satisfies the first matching constraint (e.g., which requires that difference be less than or equal to 1). Reconciliation device 210 may determine that the difference between the distribution panel port identified by the first inventory record (e.g., 3) and the distribution panel port identified by the second field record (e.g., 4) is 1 and thus satisfies the second matching constraint (e.g., which requires that the difference be less than or equal to 2). Reconciliation device 210 may also determine that the minimum difference between the distribution panel port identified by the first inventory record and the distribution panel ports identified by the set of field records is 1 and thus also does not satisfy the second matching constraint (e.g., which requires that the minimum difference be greater than 2). Reconciliation device 210 may determine that a proximity value between a terminal device 250 identified by the first inventory record (e.g., TD-4) and a terminal device 250 identified by the second field record (e.g., TD-5) have a proximity value of 1, indicating that the two terminal devices 250 may be neighboring terminal devices 250, and thus satisfies the third matching constraint. Based on the set of individual matching metrics, reconciliation device 210 may determine that the second field record is a likely match to the first inventory record.

As shown by reference number 755, reconciliation device 210 may determine that the difference between the optical splitter port identified by the first inventory record (e.g., 2) and the optical splitter port identified by the third field record (e.g., 3) is 1 and thus satisfies the first matching constraint (e.g., which requires that difference be less than or equal to 1). Reconciliation device 210 may determine that the difference between the distribution panel port identified by the first inventory record (e.g., 3) and the distribution panel port identified by the third field record (e.g., 2) is 1 and thus satisfies the second matching constraint (e.g., which requires that the difference be less than or equal to 2). Reconciliation device 210 may also determine that the minimum difference between the distribution panel port identified by the first inventory record and the distribution panel ports identified by the set of field records is 1 and thus also does not satisfy the second matching constraint (e.g., which requires that the minimum difference be greater than 2). Reconciliation device 210 may determine that a proximity value between a terminal device 250 identified by the first inventory record (e.g., TD-4) and a terminal device 250 identified by the third field record (e.g., TD-1) have a proximity value of 3, indicating that there may be multiple terminal devices 250 between the terminal device 250 associated with the first inventory record and the inventory device 250 associated with the third field record, and thus does not satisfy the third matching constraint (e.g., which requires that the terminal devices 250 be neighboring terminal devices 250). Based on the set of individual matching metrics, reconciliation device 210 may determine that the third field record does not match the first inventory record.

As shown by reference number 760, based on the matching metrics (e.g., the aggregate matching metrics and the individual matching metrics), reconciliation device 210 may determine that the first inventory record matches the second field record, and may add the first inventory record and the second field record to a set of reconciled records. As shown by reference number 765, the reconciled record may indicate that the customer associated with the first inventory record (e.g., 2517) actually receives services from the passive optical network via a fifth terminal device 250-5 (e.g., TD-5) connected to optical splitter port 2 via distribution panel port 4. In a similar manner, reconciliation device 210 may compare a second inventory record to the set of field records, a third inventory record to the set of field records, and so forth.

As shown in FIG. 7D, and by reference number 770, reconciliation device 210 may determine that a particular inventory record (e.g., identified by optical splitter port 5, distribution panel port 5, terminal device identifier TD-8, and customer ID 3131) may be a possible match with a first particular field record (e.g., associated with optical splitter port 6, distribution panel port 4, and terminal device identifier TD-7), and a second particular field record (e.g., associated with optical splitter port 5, distribution panel port 5, and terminal device identifier TD-6), based on determining that the first particular field record and the second particular field record satisfy the set of matching constraints. Based on determining that the first particular inventory record is associated with more than one possible matches, reconciliation device 210 may determine that additional field information is needed.

As shown by reference number 775, reconciliation device 210 may provide information to user device 220 instructing the field technician to remove a cross connector associated with a particular distribution panel port (e.g., distribution panel port 4). As shown by reference number 780, the field technician may remove the cross connector causing service to be disrupted from distribution device 240 to a customer (e.g., identified by customer ID 3131) via a seventh terminal device 250-7 (e.g., TD-7). As shown by reference number 785, reconciliation device 210 may receive additional field information (e.g., that customer ID 3131 is associated with seventh terminal device 250-7 and distribution panel port 4) and may update the set of field records based on the additional field information. Based on the additional field information (e.g., based on determining that customer ID 3131 is associated with distribution panel port 4), reconciliation device 210 may determine that the particular inventory record matches the first particular field record. Reconciliation device 210 may provide information to user device 220 instructing the technician to reestablish the service by replacing the cross connector associated with distribution panel port 7, and may update the inventory record to include the information from that field record.

As shown in FIG. 7E, and by reference number 790, reconciliation device 210 may complete additional iterations to identify additional reconciled records until determining that there are no more inventory records remaining. As shown by reference number 795, reconciliation device 210 may provide a notification to user device 220 indicating that the reconciliation process is finished.

As indicated above, FIGS. 7A-7E are provided merely as an example. Other examples are possible and may differ from what was described with regard to FIGS. 7A-7E.

Implementations described herein may allow a reconciliation device to automatically reconcile a set of inventory records with a set of field records, and may minimize the quantity of network devices a technician may need to manually inspect.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Certain user interfaces have been described herein. In some implementations, the user interfaces may be customizable by a device or a user. Additionally, or alternatively, the user interfaces may be pre-configured to a standard configuration, a specific configuration based on capabilities and/or specifications associated with a device on which the user interfaces are displayed, or a set of configurations based on capabilities and/or specifications associated with a device on which the user interfaces are displayed.

Some implementations are described herein in conjunction with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
receive a plurality of inventory records,
the plurality of inventory records including information that identifies how a network is supposedly configured to provide a service to a plurality of customers;
receive a plurality of field records,
the plurality of field records including information that identifies how the network is actually configured to provide the service to the plurality of customers;
determine one or more matching constraints;
compare the plurality of inventory records to the plurality of field records to determine a plurality of matching metrics;
evaluate the one or more matching constraints based on the plurality of matching metrics;
determine a plurality of reconciled records based on evaluating the one or more matching constraints,
the plurality of reconciled records including a particular inventory record, of the plurality of inventory records, and a particular field record, of the plurality of field records, that matches the particular inventory record; and
update the plurality of inventory records based on the plurality of reconciled records.

2. The device of claim 1, where the network is a passive optical network (PON);
where the plurality of inventory records include information that identifies how optical splitter ports and distribution panel ports associated with a fiber distribution hub are supposedly connected; and
where the plurality of field records include information that identifies how optical splitter ports and distribution panel ports associated with the fiber distribution hub are actually connected.

3. The device of claim 1, where the one or more processors, when receiving the plurality of field records, are further to:
send instructions to a user device to perform one or more operations; and
receive additional field information based on the one or more operations.

4. The device of claim 1, where the one or more processors, when comparing the plurality of inventory records to the plurality of field records, are further to:
determine an inventory record and field record pair,
the inventory record and field record pair including an inventory record, of the plurality of inventory records, and a field record, of the plurality of field records;
where the one or more processors, when evaluating the one or more matching constraints, are further to:
evaluate a qualifier for the inventory record and field record pair,
the qualifier including a matching constraint that, when satisfied, qualifies the inventory record as a likely match to the field record;
determine that the inventory record and field record pair qualify as a likely match based on evaluating the qualifier; and
determine that the inventory record does not qualify another field record, of the plurality of field records, as a likely match based on evaluating the qualifier.

5. The device of claim 4, where the one or more processors, when comparing the plurality of inventory records to the plurality of field records, are further to:
evaluate a disqualifier for the inventory record and field record pair,
the disqualifier including a matching constraint that, when satisfied, disqualifies the inventory record as a likely match to the field record;
determine that the inventory record and field record pair are not disqualified as a likely match based on evaluating the disqualifier; and
determine that the field record is claimed by the inventory record, and no other inventory records, as a likely match.

6. The device of claim 1, where the one or more matching constraints includes a first matching constraint and a second matching constraint;
where the one or more processors, when evaluating the one or more matching constraints, are further to:
evaluate the first matching constraint for the plurality of inventory records and the plurality of field records;
where the one or more processors, when determining the plurality of reconciled records, are further to:
determine the plurality of reconciled records based on the first matching constraint; and
where the one or more processors are further to:
evaluate the second matching constraint for the plurality of inventory records and the plurality of field records;
determine one or more additional reconciled records based on the second matching constrain; and
add the one or more additional reconciled records to the plurality of reconciled records.

7. The device of claim 1, where the one or more matching constraints include a condition that a source port associated with an inventory record be the same as a source port associated with a field record; and
where the one or more processors, when determining the plurality of reconciled records, are further to:
determine that the particular inventory record matches the particular field record based on determining that the condition is satisfied.

8. A computer-readable medium storing instructions, the instructions comprising:
one or more instructions that, when executed by one or more processors, cause the one or more processors to:
receive a plurality of inventory records,
the plurality of inventory records including information that identifies how a network is supposedly configured to provide a service to a plurality of customers;
receive a plurality of field records,
the plurality of field records including information that identifies how the network is actually configured to provide the service to the plurality of customers;
receive one or more matching constraints;
compare the plurality of inventory records to the plurality of field records based on the one or more matching constraints to determine a plurality of matching metrics;
evaluate the one or more matching constraints based on the plurality of matching metrics;
determine a plurality of reconciled records based on evaluating the one or more matching constraints,
the plurality of reconciled records including a particular inventory record, of the plurality of inventory records, and a particular field record, of the plurality of field records, that matches the particular inventory record; and
store the plurality of reconciled records.

9. The computer-readable medium of claim 8, where the one or more instructions, that cause the one or more processors to receive the one or more matching constraints, further cause the one or more processors to:
receive one or more parameters via user input from a user; and
determine the one or more matching constraints based on the one or more parameters.

10. The computer-readable medium of claim 8, where the one or more matching constraints includes a condition that a destination port associated with an inventory record be within a threshold proximity of a destination port associated with a field record; and
where the one or more instructions, that cause the one or more processors to determine the plurality of reconciled records, further cause the one or more processors to:
determine that the particular inventory record matches the particular field record based on determining that the condition is satisfied.

11. The computer-readable medium of claim 8, where the one or more instructions, that cause the one or more processors to determine the plurality of reconciled records, further cause the one or more processors to:
remove the particular inventory record from the plurality of inventory records to form a reduced set of inventory records;
remove the particular field record from the plurality of field records to form a reduced set of field records; and
where the one or more instructions, when executed by the one or more processors, further cause the one or more processors to:
compare the reduced set of inventory records to the reduced set of field records based on the one or more matching constraints;
determine one or more additional reconciled records based on comparing the reduced set of inventory records to the reduced set of field records; and
add the one or more additional reconciled records to the plurality of reconciled records.

12. The computer-readable medium of claim 8, where the one or more instructions, that cause the one or more processors to receive the one or more matching constraints, further cause the one or more processors to:
determine a proximity between a terminal device associated with another particular inventory record, of the plurality of inventory records, and a terminal device associated with another particular field record, of the plurality of field records;
where the one or more instructions, that cause the one or more processors to compare the plurality of inventory records to the plurality of field records, further cause the one or more processors to:
compare the other particular inventory record to the other particular field record based on the proximity between the terminal device associated with the other particular inventory record and the terminal device associated with the other particular field record; and
where the one or more instructions, that cause the one or more processors to determine the plurality of reconciled records, further cause the one or more processors to:
determine a reconciled record, of the plurality of reconciled records, based on the proximity between the terminal device associated with the other particular inventory record and the terminal device associated with the other particular field record.

13. The computer-readable medium of claim 12, where the one or more instructions, that cause the one or more processors to determine the proximity between the terminal device associated with the other particular inventory record and the terminal device associated with the other particular field record, further cause the one or more processors to:
determine the proximity based on at least one of:
a geographic location; or
a plurality of addresses associated with the plurality of customers.

14. The computer-readable medium of claim 8, where the one or more instructions, that cause the one or more processors to determine the one or more matching constraints, further cause the one or more processors to:
determine a plurality of proximity values associated with the plurality of inventory records,
the plurality of proximity values including a measure of proximity between a plurality of terminal devices associated with the inventory record a plurality of terminal devices associated with the field record; and
where the one or more instructions, that cause the one or more processors to compare the plurality of inventory records to the plurality of field records, further cause the one or more processors to:
compare the plurality of inventory records to the plurality of field records based on the plurality of proximity values.

15. A method, comprising:
receiving, by a device, a plurality of inventory records,
the plurality of inventory records including information that identifies how a network is supposedly configured to provide a service to a plurality of customers;
receiving, by the device, a plurality of field records,
the plurality of field records including information that identifies how the network is actually configured to provide the service to the plurality of customers;
determining, by the device, one or more matching constraints;
determining, by the device, a plurality of matching metrics;
evaluating, by the device, the one or more matching constraints based on the plurality of matching metrics;
determining, by the device, a plurality of reconciled records based on evaluating the one or more matching constraints,
the plurality of reconciled records including a particular inventory record, of the plurality of inventory records, and a particular field record, of the plurality of field records, that matches the particular inventory record; and
storing, by the device, the plurality of reconciled records.

16. The method of claim 15, further comprising:
determining, by the device, that additional field information is needed;
receiving, by the device, the additional field information;
determining, by the device, one or more additional reconciled records based on the plurality of matching constraints and based on the additional field information;
adding, by the device, the one or more additional reconciled records to the plurality of reconciled records; and
storing, by the device, the plurality of reconciled records.

17. The method of claim 16, where receiving the additional field information further comprises:
sending instructions to a user device to disrupt a service; and
determining which customers, of the plurality of customers, are without the service.

18. The method of claim 17, where disrupting the service further comprises:
determining a cross connector to be removed; and
providing instruction to a user to remove the cross connector.

19. The method of claim 16, where determining that the additional field information is needed further comprises:
determining that the additional field information is needed based on at least one of:
determining that the inventory record is a possible match with more than one field record of the plurality of field records;
determining that the inventory record does not match any field record of the plurality of field records; or
determining that a match between the inventory record and the field record is to be verified.

20. The method of claim 15, where the one or more matching constraints includes a condition that no other field record, of the plurality of field records, matches the inventory record; and
where determining the plurality of reconciled records further comprises:
determining that the particular inventory record matches the particular field record based on determining that the condition is satisfied.
